(19) United States
(12) Patent Application Publication
(10) Pub. No.: US 2014/0019905 A1
(43) Pub. Date: Jan. 16, 2014

(54) METHOD AND APPARATUS FOR CONTROLLING APPLICATION BY HANDWRITING IMAGE RECOGNITION

(71) Applicant: Samsung Electronics Co., Ltd., Suwon-si (KR)

(72) Inventors: Hwa-Kyung KIM, Seoul (KR); Sung-Soo KIM, Bucheon-si (KR); Joo-Yoon BAE, Seoul (KR); Jin-Ha JUN, Seoul (KR); Sang-Ok CHA, Suwon-si (KR)

(21) Appl. No.: 13/940,962

(22) Filed: Jul. 12, 2013

(30) Foreign Application Priority Data
Jul. 13, 2012 (KR) 10-2012-0076514
Aug. 30, 2012 (KR) 10-2012-0095965
Dec. 7, 2012 (KR) 10-2012-0142326

(51) Int. Cl. G06F 3/0484

(52) U.S. Cl. CPC G06F 3/0484
USPC 715/780

(57) ABSTRACT

A method and an apparatus for controlling an application by handwriting image recognition are provided. The method includes displaying an executed application on a touch panel, detecting a predefined user input, displaying a memo window including a handwriting input area and a non-handwriting input area over the application in response to the detected the user input, receiving and recognizing a handwriting image in the handwriting input area of the memo window, and controlling a function of the application according to a recognized result.

### PRIORITY

This application claims the benefit under 35 U.S.C. §119(a) of a Korean patent application filed on Jul. 13, 2012 in the Korean Intellectual Property Office and assigned Serial No. 10-2012-0076514, a Korean patent application filed on Aug. 30, 2012 in the Korean Intellectual Property Office and assigned Serial No. 10-2012-0095965, and a Korean patent application filed on Dec. 7, 2012 in the Korean Intellectual Property Office and assigned Serial No. 10-2012-0142326, the entire disclosure of each of which is hereby incorporated by reference.

### BACKGROUND OF THE INVENTION

1. Field of the Invention

The present invention relates to a method and an apparatus for controlling an application by handwriting image recognition. More particularly, the present invention relates to an apparatus and a method for controlling a function of a currently executed application by recognizing a handwriting input in an electronic device having a touch panel.

2. Description of the Related Art

Along with the recent growth of portable electronic devices, the demands for User Interfaces (UIs) that enable intuitive input/output are increasing. For example, traditional UIs on which information is input by means of an additional device, such as a keyboard, a keypad, a mouse, and the like, have evolved to intuitive UIs on which information is input by directly touching a screen with a finger or a touch electronic pen or by voice.

In addition, the UI technology has been developed to be intuitive and human-centered as well as user-friendly. With the UI technology, a user can talk to a portable electronic device by voice so as to input intended information or obtain desired information.

Typically, a number of applications are installed and new functions are available from the installed applications in a popular portable electronic device, such as a smart phone.

Typically, a plurality of applications installed in the smart phone are executed independently, not providing a new function or result to a user in conjunction with one another.

For example, a scheduler application allows input of information only on its supported UI in spite of a user terminal supporting an intuitive UI.

Moreover, a user uses a touch panel or a user terminal supporting a memo function through a touch panel only for the usage of writing notes with input means, such as a finger or an electronic pen, but there is no specific method for utilizing the notes in conjunction with other applications.

Therefore, a need exists for an apparatus and a method for exchanging information with a user on a handwriting-based UI in a user terminal

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for exchanging information with a user on a handwriting-based User Interface (UI) in a user terminal.

Another aspect of the present invention is to provide an apparatus and a method for controlling a function of a currently executed application by handwriting recognition in an electronic device having a touch panel. More particularly, an aspect of the present invention is to provide an apparatus and a method for controlling a function of a currently executed application by recognizing a handwriting image that a user has input to a touch panel. A user terminal is an electronic device having a touch panel. The touch panel is used in various electronic devices to provide a UI for displaying graphics and text and supporting interaction between a user and an electronic device.

Another aspect of the present invention is to provide a UI apparatus and a method for executing a specific command by a handwriting-based memo function in a user terminal.

Another aspect of the present invention is to provide a UI apparatus and a method for exchanging questions and answers with a user by a handwriting-based memo function in a user terminal.

Another aspect of the present invention is to provide a UI apparatus and a method for receiving a command to process a selected whole or part of a note that has been written on a screen by a memo function in a user terminal.

Another aspect of the present invention is to provide a UI apparatus and a method for supporting switching between memo mode and command processing mode in a user terminal supporting a memo function through an electronic pen.

Another aspect of the present invention is to provide a UI apparatus and a method for enabling input of a command to control a currently active application or another application by a memo function in a user terminal.

Another aspect of the present invention is to provide a UI apparatus and a method for analyzing a memo pattern of a user and determining information input by a memo function, taking into account the analyzed memo pattern in a user terminal.

In accordance with an aspect of the present invention, a UI method in a user terminal supporting a handwriting-based memo function is provided. The method includes, during execution of a specific application in progress, displaying a memo layer allowing handwriting over an execution screen of the specific application, upon a user request, recognizing a user's intention based on a note that the user has written in the memo layer, and controlling an operation of the specific application according to the recognized user's intention. The memo layer may take the form of a memo window. Thus the memo layer and the memo window are interchangeable in the same meaning.

In accordance with another aspect of the present invention, a UI apparatus in a user terminal supporting a handwriting-based memo function is provided. The apparatus includes an electronic device having a touch panel, in which, during execution of a specific application in progress, a memo layer allowing handwriting is displayed over an execution screen of the specific application, upon a user request, a user's intention is recognized based on a note that the user has written in the memo layer, and an operation of the specific application is controlled according to the recognized user's intention.

In accordance with another aspect of the present invention, a method for controlling an application in an electronic device having a touch panel is provided. The method includes displaying an executed application on the touch panel, displaying a predefined user input, displaying a memo window including a handwriting input area and a non-handwriting input area over the application in response to the detected user input, receiving and recognizing a handwriting image in the handwriting input area of the memo window, and controlling a function of the application according to a recognized result.

At least one of a text and an image received from the application may be displayed in the non-handwriting input area of the memo window.

When a touch on the non-handwriting area is detected, the memo window may recognize the handwriting image input to the handwriting input area, convert the recognized handwriting image to text matching the handwriting image, and provide the text to the application.

The application may separate the text received from the memo window into a command for controlling the function of the application and data related to the command.

In accordance with another aspect of the present invention, a method for controlling an application in an electronic device having a touch panel is provided. The method includes displaying a graphic object representing information related to an executed application and a button for controlling a function of the application on the touch panel, controlling the function of the application corresponding to the button, displaying, upon detection of a touch on the button, a memo window including a handwriting input area and a non-handwriting input area over the graphic object and the button on the touch panel, receiving and recognizing, upon detection of a predefined input on the touch panel, a handwriting image in the handwriting input area of the memo window, and controlling a function of the application according to a recognized result.

At least one of a text and an image received from the application may be displayed in the non-handwriting input area of the memo window.

When a touch on the text and the image is detected, the memo window may recognize the handwriting image input to the handwriting input area, convert the recognized handwriting image to text matching the handwriting image, and provide the text to the application.

When the memo window is displayed over the button, the button may be deactivated.

In accordance with another aspect of the present invention, a method for controlling an application in an electronic device having a touch panel is provided. The method includes, upon detection of a touch input, controlling a function of an executed application in a first mode, and identifying a predefined input on the touch panel during execution of the application in progress, displaying a memo window that allows a handwriting input over the application according to the identified input, recognizing a handwriting image input to the memo window, and controlling a function of the executed application according to the recognized handwriting image, in a second mode.

The first mode may be deactivated in the second mode.

In accordance with another aspect of the present invention, an electronic device is provided. The electronic device includes a touch panel for detecting a touch, and a controller for displaying an executed application on the touch panel, for displaying a memo window including a handwriting input area and a non-handwriting input area over the application in response to a predefined input detected from the touch panel, for recognizing a handwriting image to the handwriting input area of the memo window, and for controlling a function of the application according to a recognized result.

The controller may control display of a text and an image received from the application in the non-handwriting input area of the memo window.

Upon detecting a touch on the text and the image, the controller may recognize the handwriting image input to the handwriting input area, convert the recognized handwriting image to text matching the handwriting image, and control a function of the application corresponding to the text. The controller may separate the text into a command for controlling the function of the application and data related to the command.

In accordance with another aspect of the present invention, an electronic device is provided. The electronic device includes a touch panel for detecting a touch, and a controller for displaying at least one of graphic object representing information related to an executed application and a button for controlling a function of the application on the touch panel, for displaying the function of the application corresponding to the button, upon detection of a touch on the button, for displaying a memo window including a handwriting input area and a non-handwriting input area over the graphic object and the button on the touch panel, upon detection of a predefined input on the touch panel, for recognizing a handwriting image input to the handwriting input area of the memo window, and for controlling execution of a function of the application according to a recognized result.

The controller may control display of a text and an image received from the application in the non-handwriting input area of the memo window. Upon detecting a touch on the text and the image, the controller may recognize the handwriting image input to the handwriting input area, convert the recognized handwriting image to text matching the handwriting image, and control a function of the application corresponding to the text. When the memo window is displayed over the button, the controller may control deactivation of the button.

In accordance with another aspect of the present invention, an electronic device is provided. The electronic device includes a touch panel for detecting a touch, and a controller for operating in a first mode, wherein the controller controls a function of an executed application, upon detection of a touch input, and operates in a second mode in which the controller identifies a predefined input on the touch panel during execution of the application in progress, displays a memo window that allows a handwriting input over the application according to the identified input, recognizes a handwriting image input to the memo window, and controls a function of the executed application according to the recognized handwriting image.

In accordance with another aspect of the present invention, an electronic device is provided. The electronic device includes a touch panel for detecting a touch, and a controller for displaying at least one of graphic object representing information related to an executed application and a button for controlling a function of the application on the touch panel, wherein the controller controls execution of the function of the application corresponding to the button, upon detection of a touch on the button, displays a memo window allowing a handwriting input over a screen displaying the graphic object and the button on the touch panel, upon detection of a predefined input on the touch panel, recognizes a handwriting image input to the memo window, and controls execution of a function of the application according to a recognized result.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a user terminal supporting a handwriting-based Natural Language Interaction (NLI) according to an exemplary embodiment of the present invention;

FIG. 2 is a block diagram of a command processor for supporting a handwriting-based NLI in a user terminal according to an exemplary embodiment of the present invention;

FIG. 3 is a flowchart illustrating a control operation for supporting a User Interface (UI) using a handwriting-based NLI in a user terminal according to an exemplary embodiment of the present invention;

FIG. 4 illustrates requesting an operation based on a specific application or function by a memo function according to an exemplary embodiment of the present invention;

FIG. 5 illustrates a user's actual memo pattern according to exemplary embodiments of the present invention;

FIG. 6 illustrates one symbol being interpreted as various meanings according to an exemplary embodiment of the present invention;

FIG. 7 illustrates input information including a combination of a text and a symbol being interpreted as having different meanings depending on the symbol according to an exemplary embodiment of the present invention;

FIG. 8 illustrates uses of signs and symbols in semiotics according to an exemplary embodiment of the present invention;

FIG. 9 illustrates uses of signs and symbols in mechanical/electrical/computer engineering and chemistry according to an exemplary embodiment of the present invention;

FIGS. 10 through 17 illustrate operation scenarios based on applications supporting a memo function according to an exemplary embodiment of the present invention;

FIG. 18 illustrates a configuration for controlling an activated application by a memo function in a user terminal according to an exemplary embodiment of the present invention;

FIG. 19 is a flowchart illustrating a control operation for controlling a lower-layer application by invoking a memo layer in a user terminal according to an exemplary embodiment of the present invention;

FIGS. 20A through 20C illustrate operations of invoking a memo layer in a user terminal according to an exemplary embodiment of the present invention;

FIGS. 21A through 21D illustrate a user writing a note on a memo layer displayed on a screen in a user terminal according to an exemplary embodiment of the present invention;

FIGS. 22A through 22D illustrate controlling a currently executed specific application using a memo layer in a user terminal according to an exemplary embodiment of the present invention;

FIGS. 23 through 28 illustrate scenarios of invoking an application supporting a memo function after a specific application is activated and executing the activated application by the invoked application according to exemplary embodiments of the present invention;

FIGS. 29 and 30 illustrate scenarios related to semiotics according to exemplary embodiments of the present invention;

FIG. 31 is a flowchart illustrating a control operation for controlling a lower-layer application by invoking a memo layer in a user terminal according to an exemplary embodiment of the present invention;

FIGS. 32A through 36B illustrate operation scenarios of controlling a currently executed lower-layer application using a memo window in an electronic device having a touch panel according to exemplary embodiments of the present invention; and

FIGS. 37A and 37B illustrate software modules included in a lower-layer application and a memo-layer (memo-window) application according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention will be provided to achieve the above-described technical aspects of the present invention. In an exemplary implementation, defined entities may have the same names, to which the present invention is not limited. Thus, exemplary embodiments of the present invention can be implemented with same or ready modifications in a system having a similar technical background.

Exemplary embodiments of the present invention are intended to enable a question and answer procedure with a user by a memo function in a user terminal to which a handwriting-based User Interface (UI) technology is applied through a Natural Language Interaction (NLI) (hereinafter, referred to as ‘handwriting-based NLI’).

NLI generally involves understanding and creation. With the understanding and creation functions, a computer understands an input and displays text readily understandable to humans. Thus, it can be said that NLI is an application of natural language understanding that enables a dialogue in a natural language between a person and an electronic device.

For example, a user terminal executes a command received from a user or acquires information required to execute the input command from the user in a question and answer procedure through a handwriting-based NLI.

To apply handwriting-based NLI to a user terminal, it is preferred that switching should be performed organically between a memo mode and a command processing mode through a handwriting-based NLI in exemplary embodiments of the present invention. In the memo mode, a user writes a note on a screen displayed by an activated application with input means, such as a finger or an electronic pen in a user terminal, whereas in the command processing mode, a note written in the memo mode is processed in conjunction with information associated with the currently activated application.

For example, upon pressing of a button of an electronic pen, that is, upon generation of a signal in hardware, switching may occur between the memo mode and the command processing mode.

While the following description is given in the context of an electronic pen being used as a major input means to support a memo function, exemplary embodiments of the present invention are not limited to a user terminal using an electronic pen as an input means. In other words, it is to be understood that any device with which a user can input information on a touch panel can be used as an input means in exemplary embodiments of the present invention.

Preferably, information is shared between a user terminal and a user in a preliminary mutual agreement so that the user terminal may receive intended information from the user by exchanging a question and an answer with the user and thus, may provide the result of processing the received information to the user through the handwriting-based NLI of exemplary embodiments of the present invention. For example, it may be agreed that in order to request operation mode switching, at least one of a symbol, a pattern, a text, and a combination thereof is used or a motion is used by a gesture input recognition function. Mainly, a memo mode-to-command processing mode switching or a command processing mode-to-memo mode switching may be requested.

In regard to agreement on input information corresponding to a symbol, a pattern, a text, or a combination thereof, it is preferred to analyze a user's memo pattern and consider the analysis result, to thereby enable a user to intuitively input intended information with convenience.

Various scenarios of controlling various activated applications by a memo function based on a handwriting-based NLI and outputting the control results will be described as separate exemplary embodiments of the present invention.

For example, a description will be given of a scenario of selecting all or a part of a note and processing the selected note contents by a specific command, a scenario of inputting specific information to a screen of a specific activated application by a memo function, a scenario of processing a specific command in a question and answer procedure using handwriting-based NLI, and the like.

Reference will be made to exemplary embodiments of the present invention with reference to the attached drawings. Like reference numerals denote the same components in the drawings. A description of a generally known function and structure of exemplary embodiments of the present invention will be avoided lest it should obscure the subject matter of the present invention.

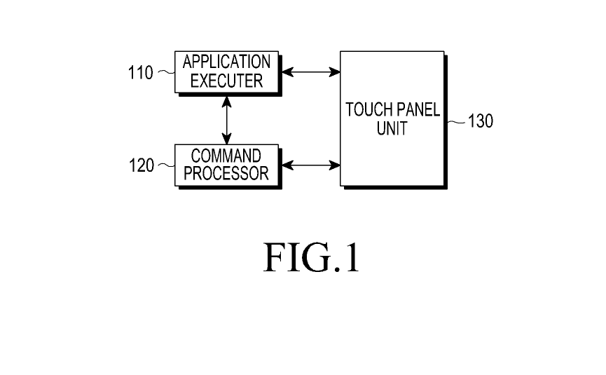

FIG. 1 is a block diagram of a user terminal supporting a handwriting-based NLI according to an exemplary embodiment of the present invention. While only components of the user terminal required to support a handwriting-based NLI are shown in FIG. 1, it is clear that components may be added to the user terminal in order to perform other functions. It is also possible to configure each component illustrated in FIG. 1 in the form of a software function block as well as a hardware function block.

Referring to FIG. 1, an application executer 110 installs an application received through a network or an external interface in conjunction with a memory (not shown), upon a user request. The application executer 110 activates one of installed applications, upon the user request and controls the activated application according to an external command. The external command refers to almost any of externally input commands other than internally generated commands.

For example, the external command may be a command corresponding to information input through handwriting-based NLI by the user as well as a command corresponding to information input through a network. In an exemplary implementation, the external command is limited to a command corresponding to information input through handwriting-based NLI by a user, which should not be construed as limiting exemplary embodiments of the present invention.

The application executer 110 provides the result of installing or activating a specific application to the user through handwriting-based NLI. For example, the application executer 110 outputs the result of installing or activating a specific application on a display of a touch panel unit 130. The touch panel unit 130 may detect a touch.

The touch panel unit 130 is configured to process input/output of information through handwriting-based NLI. The touch panel unit 130 performs a display function and an input function. The display function generically refers to a function of displaying information on a screen and the input function generically refers to a function of receiving information from a user.

However, it is obvious that the user terminal may include an additional structure for performing the display function and the input function. For example, the user terminal may further include a camera for detecting a motion.

In an exemplary implementation, the touch panel unit 130 will be described as performing the display function and the input function, with no distinction made between the display function and the input function regarding the operations of the touch panel unit 130. The touch panel unit 130 recognizes specific information or a specific command from the user and provides the recognized information or command to the application executer 110 and/or a command processor 120.

The information may be information about a note written by the user or information about an answer in a question and answer procedure based on handwriting-based NLI. Moreover, the information may be information for selecting a whole or part of a note displayed on a current screen.

The command may be a command requesting installation of a specific application or a command requesting activation of a specific application from among already installed applications. The command may be a command requesting execution of a specific operation, function, and the like, supported by a selected application.

The information or command may be input in the form of a line, a symbol, a pattern, or a combination thereof as well as a text. Such a line, a symbol, a pattern, and the like, may be preset by an agreement.

The touch panel unit 130 displays on a screen the result of activating a specific application or performing a specific function of the activated application by the application executer 110.

The touch panel unit 130 also displays a question or a result on a screen in a question and answer procedure. For example, when the user inputs a specific command, the touch panel unit 130 displays the result of processing the specific command, received from the command processor 120 or displays a question to acquire additional information required to process the specific command from the user. Upon receipt of the additional information as an answer to the question from the user, the touch panel unit 130 provides the received additional information to the command processor 120.

Subsequently, the touch panel unit 130 displays an additional question to acquire other information upon request of the command processor 120 or displays the result of processing the specific command, reflecting the received additional information.

The command processor 120 receives a user-input text, a symbol, an image, a pattern, and the like, from the touch panel unit 130 and identifies a user-intended input by the text, the symbol, the image, the pattern, and the like.

For example, the command processor 120 may recognize the user-intended input by natural language processing of the received text, symbol, image, pattern, and the like. For the natural language processing, the command processor 120 employs a handwriting-based NLI. The user-intended input includes a command requesting activation of a specific application or execution of a specific function in a current active application, or an answer to a question.

When the command processor 120 determines that the user-intended input is a command requesting a certain operation, the command processor 120 processes the determined command. Specifically, the command processor 120 may command the application executer 110 to activate a specific application or to execute a specific function of a currently active application, according to the determined command. In this case, the command processor 120 receives a processed result from the application executer 110 and provides the processed result to the touch panel unit 130.

The application executer 110 may provide the processed result directly to the touch panel unit 130, not to the command processor 120.

If additional information is needed to process the determined command, the command processor 120 creates a question to acquire the additional information and provides the question to the touch panel unit 130. Thereafter, the command processor 120 may receive an answer to the question from the touch panel unit 130.

The command processor 120 may continuously exchange questions and answers with the user, that is, may continue a dialogue with the user through the touch panel unit 130 until acquiring sufficient information to process the determined command. For example, the command processor 120 may repeat the question and answer procedure through the touch panel unit 130.

To perform the above-described operation, the command processor 120 adopts handwriting-based NLI by interworking with the touch panel unit 130. For example, the command processor 120 enables questions and answers, that is, a dialogue between a user and an electronic device by a memo function through a handwriting-based natural language interface. The user terminal processes a user command or provides the result of processing the user command to the user in the dialogue.

The touch panel unit 130 may detect a touch. The command processor 120 and the application executer 110 may be incorporated into a controller (not shown), or the controller may be configured so as to perform the operations of the command processor 120 and the application executer 110. The controller may display an executed application on a touch panel and may display a memo window over the application in response to a predefined gesture detected from the touch panel. The memo window is divided into a handwriting input area and a non-handwriting input area. A user's touch input may be detected in the handwriting input area, whereas a user's touch input may be neglected in the non-handwriting input area. The predefined gesture may be a touch and drag that the user makes on the touch panel with his or her finger or an electronic pen. The predefined gesture may be a user's drawing of a specific shape or pattern on the touch panel by means of a finger or an electronic pen.

The controller may recognize a handwriting image input to the handwriting input area of the memo window and may control execution of a function of the application according to the recognized result.

When the user writes a note in the handwriting input area of the memo window, the controller may recognize a handwriting image of the note and output text corresponding to the recognized handwriting image.

A handwriting image may be generated by a user's action of writing a note on a touch panel with an electronic pen. A memo window has its unique title and the title of a memo window varies with an executed application. For example, a currently executed application has information about the title of a memo window that will be displayed in the memo window.

The controller may control display of a text and images received from the application in the non-handwriting input area of the memo window. The text may be the title of the memo window and the image may be an icon.

When the user touches the image, the memo window may disappear. For example, the icon is equivalent to a button that the user can manipulate.

Upon detecting a touch on the text or the image, the controller may recognize the handwriting image of the note written in the handwriting input area, converts the handwriting image to matching text, and control a function of the application based on the text. The text may be a command or data for which a command is to be executed.

The controller may identify the text as a command for controlling the function of the application or data associated with the command.

According to an exemplary embodiment of the present invention, an electronic device may include a touch panel for detecting a touch and a controller. The controller may control display of a graphic object representing information associated with an executed application and a button for controlling a function of the application on the touch panel. Upon execution of an application, a graphic object including a text or an image may be displayed on the touch panel. In addition, a button may be displayed on the touch panel, for receiving a command from the user to control a function of the application. When the user touches the button, a command assigned to the button is transmitted to the application.

Upon detection of the touch on the button, the controller may control the function of the application. In addition, upon detection of a predefined gesture on the touch panel, the controller may display a memo window overlapped with the graphic object and the button on the touch panel. For example, when the user drags on the touch panel, the memo window may be displayed.

The memo window may be divided into a handwriting input area and a non-handwriting input area. The controller may recognize a handwriting image input to the handwriting input area and may control execution of a function of the application according to the recognized result.

The controller may control display of a text and an image received from the application in the non-handwriting input area of the memo window.

Upon detecting a touch on the text or the image in the memo window, the controller may recognize the handwriting image input to the handwriting input area, convert the handwriting image into matching first text, and control a function of the application according to the first text. The first text is obtained from the recognized result of the handwriting image.

The controller may also display second text indicating a function of the button on the button. If the first text fully or partially matches the second text on the button, the controller may execute a function of the application corresponding to the button. The first text may perfectly match the second text. Alternatively, the first text may partially match the second text. For example, if the first text resulting from recognizing a user-input handwriting image is ‘delete’ and the second text labeled on the button is ‘delete item’, the first text partially matches the second text. In this case, the controller may control execution of a ‘delete’ command corresponding to the first text from among the functions of the application.

When the memo window is displayed over the button in an overlapped manner, the controller may control deactivation of the button. The memo window may be rendered semi-transparent. Since the memo window lies over the button, the controller deactivates the button. A touch input detected from the position of the button may be neglected.

In an exemplary embodiment of the present invention, the electronic device may display a touch panel and display a graphic object representing information about an executed application and a button for controlling a function of the application on the touch panel. When the button is touched, the electronic device may control execution of the function of the application corresponding to the button. Upon input of a predefined gesture on the touch panel, the electronic device may display a memo window allowing handwriting inputs, over the screen that displays the graphic object and the button, recognize an input handwriting image in the memo window, and control execution of a function of the application according to the recognized result.

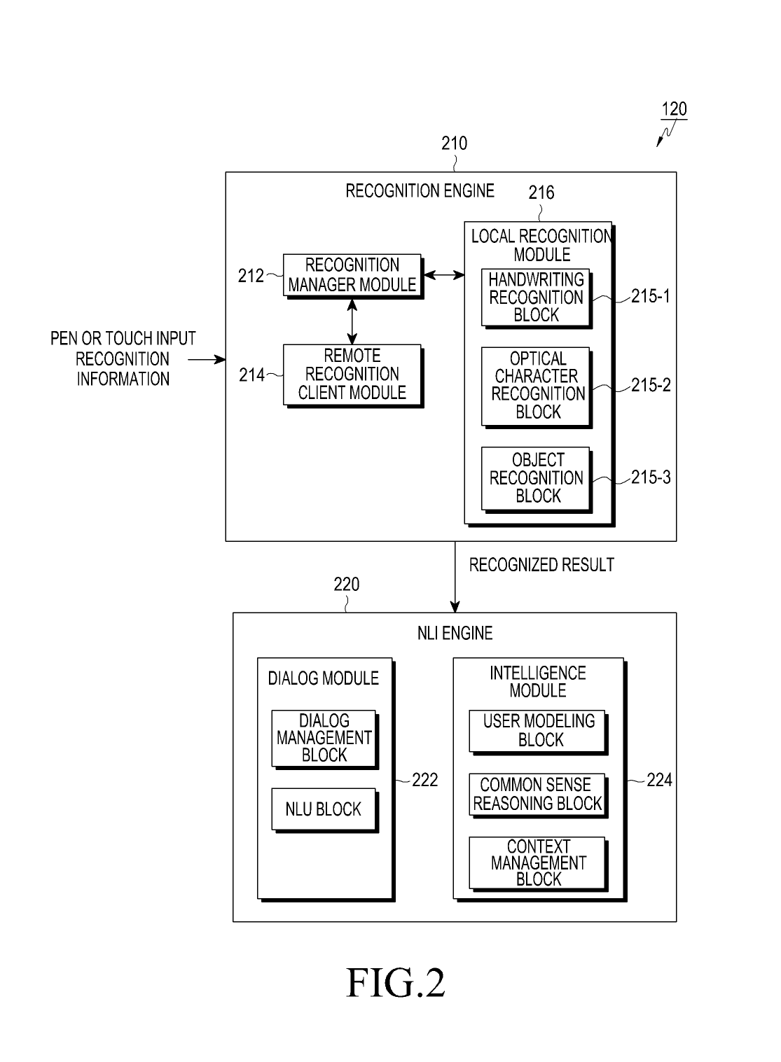

FIG. 2 is a block diagram of a command processor for supporting a handwriting-based NLI in a user terminal according to an exemplary embodiment of the present invention.

Referring to FIG. 2, the command processor 120 supporting handwriting-based NLI includes a recognition engine 210 and an NLI engine 220.

The recognition engine 210 includes a recognition manager module 212, a remote recognition client module 214, and a local recognition module 216. The local recognition module 216 includes a handwriting recognition block 215-1, an optical character recognition block 215-2, and an object recognition block 215-3.

The NLI engine 220 includes a dialog module 222 and an intelligence module 224. The dialog mobile 222 includes a dialog management block for controlling a dialog flow and a Natural Language Understanding (NLU) block for recognizing a user's intention. The intelligence module 224 includes a user modeling block for reflecting user preferences, a common sense reasoning block for reflecting common sense, and a context management block for reflecting a user situation.

The recognition engine 210 may receive information from a drawing engine corresponding to input means, such as an electronic pen and an intelligent input platform, such as a camera. The intelligent input platform (not shown) may be an optical character recognizer, such as an Optical Character Reader (OCR). The intelligent input platform may read information taking the form of printed or handwritten text, numbers, or symbols and provide the read information to the recognition engine 210. The drawing engine is a component for receiving an input from input means, such as a finger, an object, a pen, and the like. The drawing engine may detect input information received from the input means and provide the detected input information to the recognition engine 210. Thus, the recognition engine 210 may recognize information received from the intelligent input platform and the touch panel unit 130.

A case where the touch panel unit 130 receives inputs from input means and provides touch input recognition information and pen input recognition information to the recognition engine 210 will be described in an exemplary embodiment of the present invention, by way of example.

According to an exemplary embodiment of the present invention, the recognition engine 210 recognizes a user-selected whole or part of a currently displayed note or a user-selected command from a text, a line, a symbol, a pattern, an image, or a combination thereof received as information. The user-selected command is a predefined input. The user-selected command may correspond to at least one of a preset symbol, a pattern, a text, or a combination thereof or at least one gesture preset by a gesture recognition function.

The recognition engine 210 outputs a recognized result obtained in the above operation.

For this purpose, the recognition engine 210 includes the recognition manager module 212 for providing overall control to output a recognized result of input information, the remote recognition client module 214, and the local recognition module 216 for recognizing input information. The local recognition module 216 includes at least a handwriting recognition block 215-1 for recognizing handwritten input information, an optical character recognition block 215-2 for recognizing information from an input optical signal, and an object recognition block 215-3 for recognizing information from an input gesture.

The handwriting recognition block 215-1 recognizes handwritten input information. For example, the handwriting recognition block 215-1 recognizes a note that the user has written on a memo screen with the touch pen 20. Specifically, the handwriting recognition block 215-1 receives the coordinates of points touched on the memo screen from the touch panel unit 130, stores the coordinates of the touched points as strokes, and generates a stroke array using the strokes. The handwriting recognition block 215-1 recognizes the contents of the handwritten note using a pre-stored handwriting library and a stroke array list including the generated stroke array. The handwriting recognition block 215-1 outputs the resulting recognized results corresponding to note contents and a command in the recognized contents.

The optical character recognition block 215-2 receives an optical signal detected by the optical detecting module and outputs an optical character recognized result. The object recognition block 215-3 receives a gesture detecting signal detected by the motion detecting module, recognizes a gesture, and outputs a gesture recognized result.

The recognized results output from the handwriting recognition block 215-1, the optical character recognition block 215-2, and the object recognition block 215-3 are provided to the NLI engine 220 or the application executer 110.

The NLI engine 220 determines the intention of the user by processing, for example, analyzing the recognized results received from the recognition engine 210. For example, the NLI engine 220 determines user-intended input information from the recognized results received from the recognition engine 210. Specifically, the NLI engine 220 collects sufficient information by exchanging questions and answers with the user based on handwriting-based NLI and determines the intention of the user based on the collected information.

For this operation, the dialog module 222 of the NLI engine 220 creates a question to make a dialog with the user and provides the question to the user, thereby controlling a dialog flow to receive an answer from the user. The dialog module 222 manages information acquired from questions and answers (the dialog management block). The dialog module 222 also understands the intention of the user by performing a natural language process on an initially received command, taking into account the managed information (the NLU block).

The intelligence module 224 of the NLI engine 220 generates information to be referred to for understanding the intention of the user through the natural language process and provides the reference information to the dialog module 222. For example, the intelligence module 224 models information reflecting a user preference by analyzing a user's habit in making a note (the user modeling block), induces information for reflecting common sense (the common sense reasoning block), or manages information representing a current user situation (the context management block).

Therefore, the dialog module 222 may control a dialog flow in a question and answer procedure with the user with the help of information received from the intelligence module 224.

Meanwhile, the application executer 110 receives a recognized result corresponding to a command from the recognition engine 210, searches for the command in a pre-stored synonym table, and reads an IDentifier (ID) corresponding to a synonym matching the command, in the presence of the synonym matching the command in the synonym table. The application executer 110 executes a method corresponding to the ID listed in a pre-stored method table. Accordingly, the method executes an application corresponding to the command and the note contents are provided to the application. The application executer 110 executes an associated function of the application using the note contents.

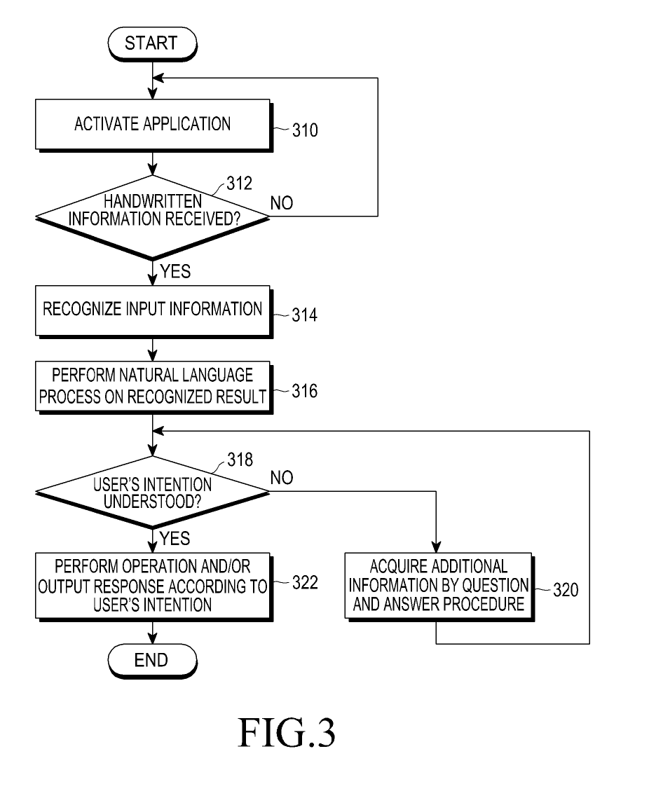

FIG. 3 is a flowchart illustrating a control operation for supporting a UI using a handwriting-based NLI in a user terminal according to an exemplary embodiment of the present invention.

Referring to FIG. 3, the user terminal activates a specific application and provides a function of the activated application in step 310. The specific application is an application of which the activation has been requested by the user from among applications installed in the user terminal, upon a user request.

For example, the user may activate the specific application by the memo function of the user terminal. For example, the user terminal launches a memo layer on a screen, upon a user request. Thereafter, upon receipt of identification information of the specific application and information corresponding to an execution command, the user terminal searches for the specific application and activates the detected application. This method is useful in fast executing an intended application from among a large number of applications installed in the user terminal.

The identification information of the specific application may be the name of the application, for example. The information corresponding to the execution command may be an image, a symbol, a pattern, a text, and the like, preset to command activation of the application.

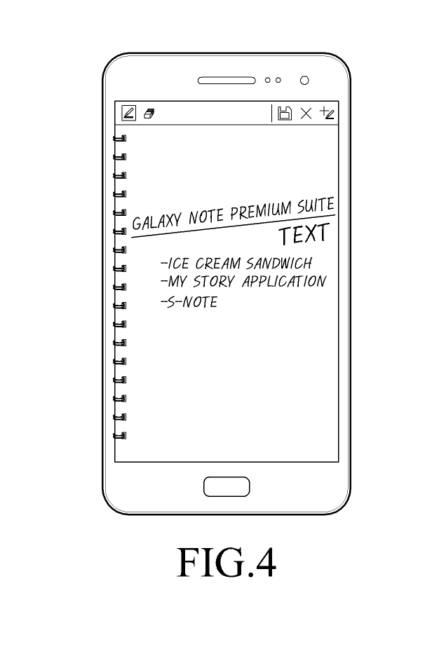

FIG. 4 illustrates requesting an operation based on a specific application or function by a memo function according to an exemplary embodiment of the present invention.

Referring to FIG. 4, a part of a note written by the memo function is selected using a line, a closed loop, an image, or the like, and the selected note contents are processed using another application. For example, note contents “galaxy note premium suite’ is selected using a line and a command is issued to send the selected note contents using a text sending application.

If there is no application matching the user input in the user terminal, a candidate set of similar applications may be provided to the user so that the user may select an intended application from among the candidate applications.

In another example, a function supported by the user terminal may be executed by the memo function. For this purpose, the user terminal invokes a memo layer upon a user request and searches for an installed application according to user-input information.

For instance, a search keyword is input to a memo screen displayed for the memo function in order to search for a specific application among applications installed in the user terminal. Thereafter, the user terminal searches for the application matching the input keyword. For example, if the user writes ‘car game’ on the screen by the memo function, the user terminal searches for applications related to ‘car game’ among the installed applications and provides the search results on the screen.

In another example, the user may input an installation time, for example, February 2011 on the screen by the memo function. Thereafter, the user terminal searches for applications installed in February 2011. For example, when the user writes ‘February 2011’ on the screen by the memo function, the user terminal searches for applications installed in ‘February 2011’ among the installed applications and provides the search results on the screen.

As described above, activation of or search for a specific application based on a user's note is useful, in the case where a large number of applications are installed in the user terminal.

For more efficient search for applications, the installed applications are preferably indexed. The indexed applications may be classified by categories, such as feature, field, function, and the like.

Upon a user input of a specific key or gesture, the memo layer may be invoked to allow the user to input identification information of an application to be activated or to input index information to search for a specific application.

Specific applications activated or searched for in the above-described manner include a memo application, a scheduler application, a map application, a music application, and a subway application.

Referring back to FIG. 3, upon activation of the specific application, the user terminal monitors input of handwritten information in step 312. The input information may take the form of a line, a symbol, a pattern, or a combination thereof as well as a text. The user terminal may monitor input of information indicating an area that selects a whole or part of the note written on the current screen.

If the note is partially or wholly selected, the user terminal continuously monitors additional input of information corresponding to a command in order to process the selected note contents in step 312.

Upon detecting input of handwritten information, the user terminal performs an operation for recognizing the detected input information in step 314. For example, text information of the selected whole or partial note contents is recognized or the input information taking the form of a line, a symbol, a pattern, or a combination thereof in addition to a text is recognized. The recognition engine 210 illustrated in FIG. 2 is responsible for recognizing the input information.

Once the user terminal recognizes the detected input information, the user terminal performs a natural language process on the recognized text information to understand the contents of the recognized text information. The NLI engine 220 is responsible for the natural language process of the recognized text information.

If determining that the input information is a combination of a text and a symbol, the user terminal also processes the symbol along with the natural language process.

In the symbol process, the user terminal analyzes an actual memo pattern of the user and detects a main symbol that the user frequently uses by the analysis of the memo pattern. Thereafter, the user terminal analyzes the intention of using the detected main symbol and determines the meaning of the main symbol based on the analysis result.

The meaning that the user intends for each main symbol is built into a database, for later use in interpreting a later input symbol. For example, the prepared database may be used for symbol processing.

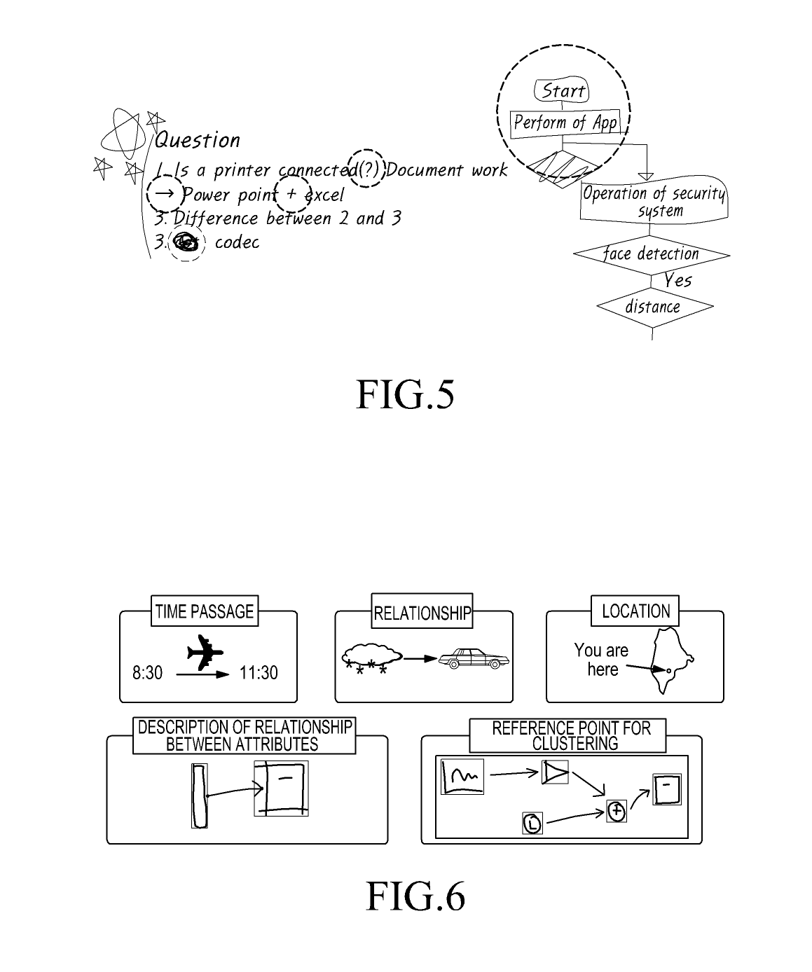

FIG. 5 illustrates a user's actual memo pattern according to exemplary embodiments of the present invention.

Referring to FIG. 5, the user frequently uses symbols →, ( ), _, −, +, and ?. For example, symbol → is used for additional description or paragraph separation and symbol ( ) indicates that the contents within ( ) is a definition of a term or a description.

The same symbol may be interpreted as having different meanings. For example, symbol → may signify ‘time passage’, ‘causal relationship’, ‘position’, ‘description of relationship between attributes’, ‘reference point for clustering’, ‘change’, and the like.

FIG. 6 illustrates one symbol being interpreted as various meanings according to an exemplary embodiment of the present invention.

Referring to FIG. 6, symbol → may be used in the meanings of time passage, causal relationship, position, and the like.

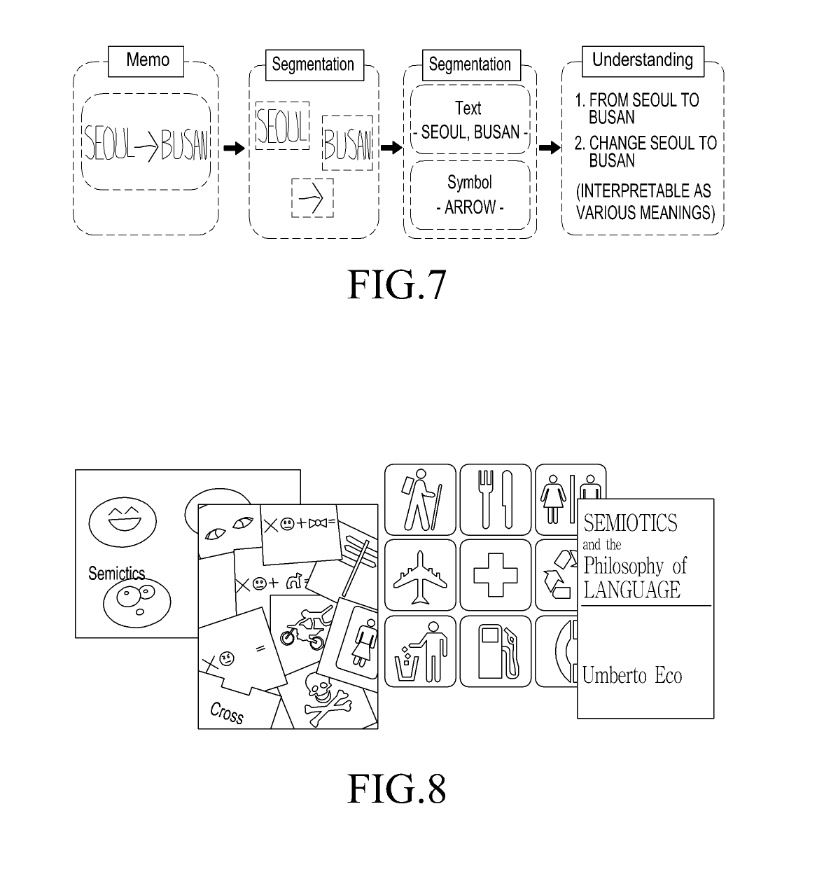

FIG. 7 illustrates input information including a combination of a text and a symbol being interpreted as having different meanings depending on the symbol according to an exemplary embodiment of the present invention.

Referring to FIG. 7, user-input information ‘Seoul→Busan’ may be interpreted to imply that ‘Seoul is changed to ‘Busan’ as well as ‘from Seoul to Busan’. The symbol that allows a plurality of meanings may be interpreted, taking into account additional information or the relationship with previous or following information. However, this interpretation may lead to inaccurate assessment of the user's intention.

To address this issue, extensive research and efforts on symbol recognition/understanding are required. For example, the relationship between symbol recognition and understanding is under research in semiotics of the liberal arts field and the research is utilized in advertisements, literature, movies, traffic signals, and the like. Semiotics is, in its broad sense, the theory and study of functions, analysis, interpretation, meanings, and representations of signs and symbols, and various systems related to communication.

Signs and symbols are also studied from the perspective of engineering science. For example, research is conducted on symbol recognition of a flowchart and a blueprint in the field of mechanical/electrical/computer engineering. The research is used in sketch (hand-drawn diagram) recognition. Furthermore, recognition of complicated chemical structure formulas is studied in chemistry and this study is used in hand-drawn chemical diagram recognition.

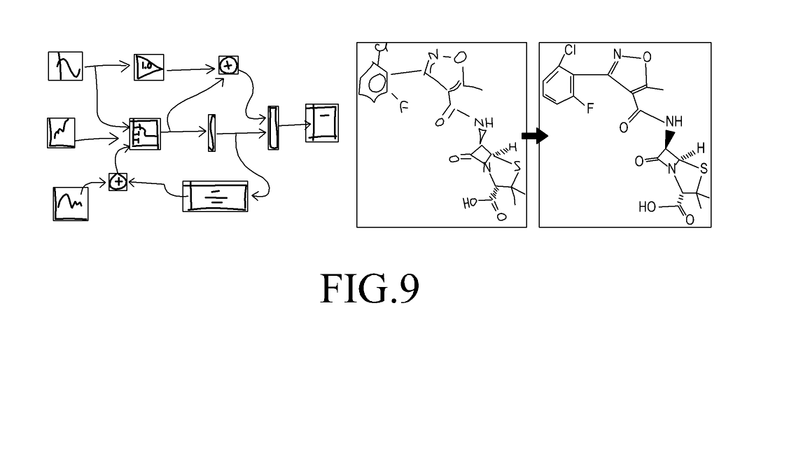

FIG. 8 illustrates uses of signs and symbols in semiotics according to an exemplary embodiment of the present invention and FIG. 9 illustrates uses of signs and symbols in mechanical/electrical/computer engineering and chemistry according to an exemplary embodiment of the present invention.

Referring back to FIG. 3, the user terminal understands the contents of the user-input information by the natural language process of the recognized result and assesses the intention of the user regarding the input information based on the recognized contents in step 318.

Once the user terminal determines the user's intention regarding the input information, the user terminal performs an operation corresponding to the user's intention or outputs a response corresponding to the user's intention in step 322. After performing the operation corresponding to the user's intention, the user terminal may output the result of the operation to the user.

On the contrary, if the user terminal fails to assess the user's intention regarding the input information, the user terminal acquires additional information by a question and answer procedure with the user to determine the user's intention in step 320. For this purpose, the user terminal creates a question to ask the user and provides the question to the user. When the user inputs additional information by answering the question, the user terminal re-assesses the user's intention, taking into account the new input information in addition to the contents understood previously by the natural language process.

While not shown, the user terminal may additionally perform steps 314 and 316 to understand the new input information.

Until assessing the user's intention accurately, the user terminal may acquire most of information required to determine the user's intention by exchanging questions and answers with the user, that is, by making a dialog with the user in step 320.

Once the user terminal determines the user's intention in the question and answer procedure, the user terminal outputs the result of an operation corresponding to the user's intention or outputs a response result corresponding to the user's intention to the user in step 322.

The configuration of the UI apparatus in the user terminal and the UI method using handwriting-based NLI in the UI apparatus may be considered in various scenarios.

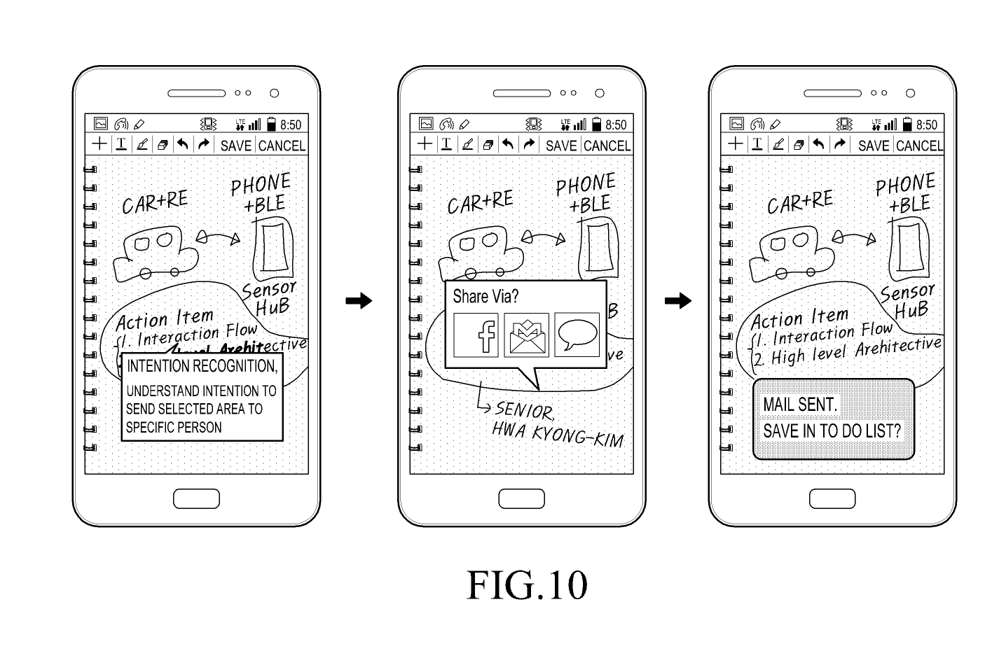

FIGS. 10 through 17 illustrate operation scenarios based on applications supporting a memo function according to an exemplary embodiment of the present invention.

More specifically, FIGS. 10 through 17 illustrate processing a note that a user has input in an application supporting the memo function, by invoking another application.

FIG. 10 illustrates a scenario of sending a part of a note by mail using a memo function in a user terminal according to an exemplary embodiment of the present invention.

Referring to FIG. 10, the user writes a note on a screen of the user terminal by the memo function and selects a part of the note by means of a line, a symbol, a closed loop, and the like. For example, a partial area of the whole note may be selected by drawing a closed loop, thereby selecting the contents of the note within the closed loop.

Thereafter, the user inputs a command requesting processing the selected contents using a preset or an intuitively recognizable symbol and text. For example, the user draws an arrow indicating the selected area and writes text indicating a person (Senior, Hwa Kyong-KIM).

Upon receipt of the information, the user terminal interprets the user's intention as meaning that the note contents of the selected area are to be sent to ‘Senior, Hwa Kyong-KIM’. Thereafter, the user terminal extracts recommended applications capable of sending the selected note contents from among installed applications and displays the extracted recommended applications on the screen so that the user may request selection or activation of a recommended application.

When the user selects one of the recommended applications, the user terminal launches the selected application and sends the selected note contents to ‘Senior, Hwa Kyong-KIM’ by the application.

If information about the recipient is not pre-registered, the user terminal may ask the user a mail address of ‘Senior, Hwa Kyong-KIM’. In this case, the user terminal may send the selected note contents in response to reception of the mail address from the user.

After processing as intended by the user, the user terminal displays the processed result on the screen so that the user may confirm appropriate processing conforming the user's intention. For example, the user terminal asks the user whether to store details of the sent mail in a list, while displaying a message indicating completion of the mail sending. When the user requests to store the details of the sent mail in the list, the user terminal registers the details of the sent mail in the list.

The above scenario can help to increase throughput by allowing the user terminal to send necessary contents of a note written down during a conference to the other party without the need for shifting from one application to another and store details of the sent mail through interaction with the user.

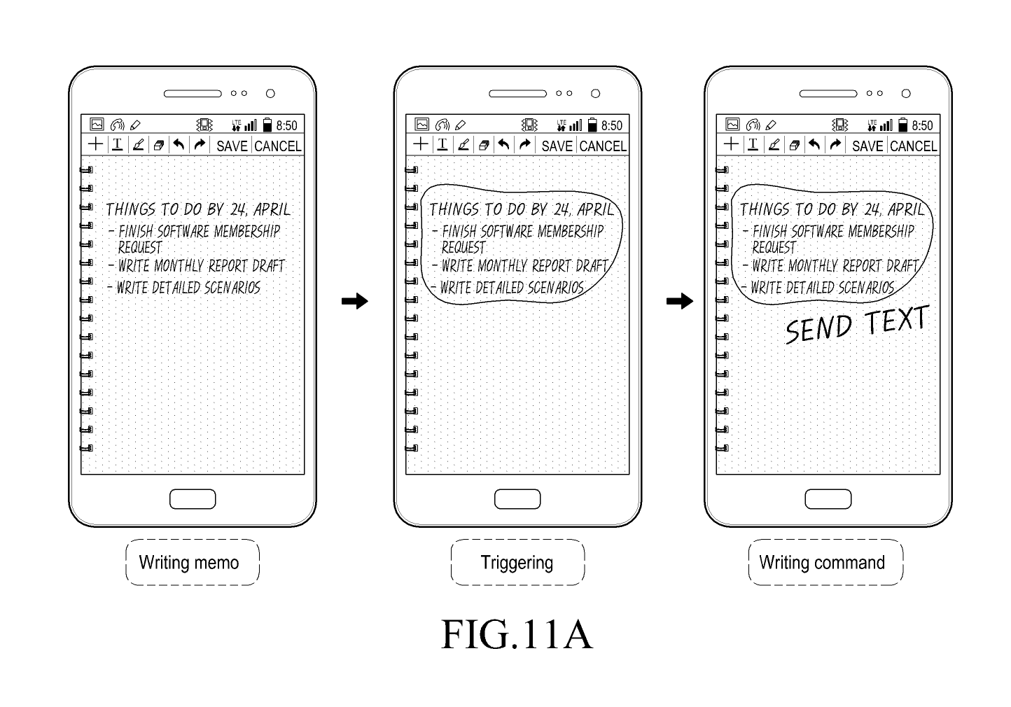

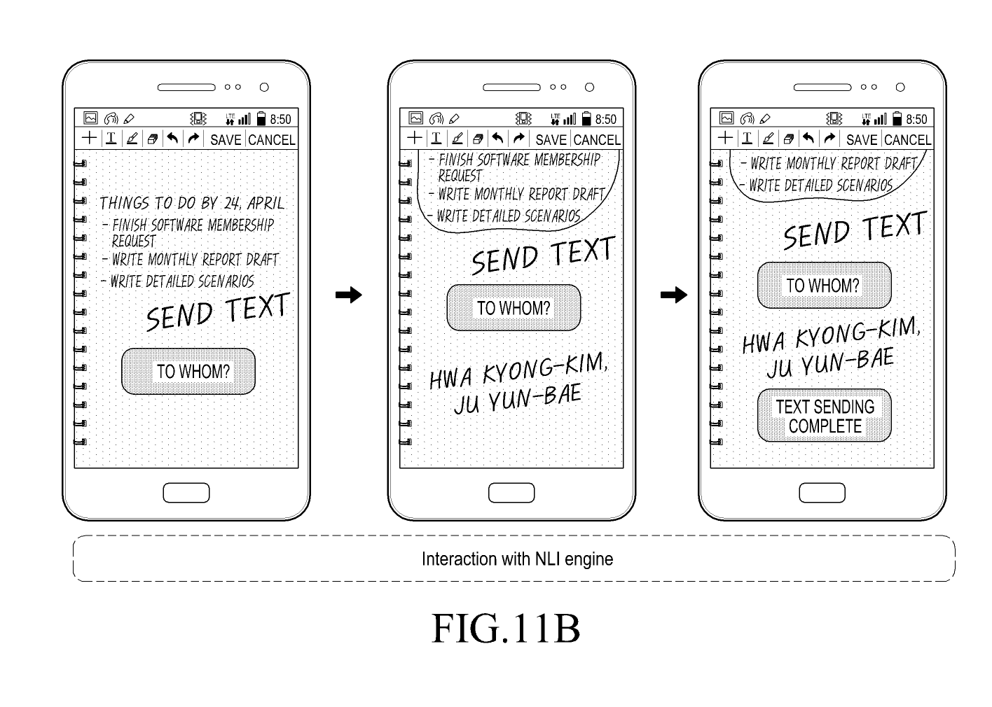

FIGS. 11A and 11B illustrate a scenario in which a user terminal sends a whole note by a memo function according to an exemplary embodiment of the present invention.

Referring to FIGS. 11A and 11B, the user writes a note on a screen by the memo function (Writing memo). Thereafter, the user selects the whole note using a line, a symbol, a closed loop, and the like. (Triggering). For example, when the user draws a closed loop around the full note, the user terminal may recognize that the whole contents of the note within the closed loop are selected.

The user requests text-sending of the selected contents by writing a preset or an intuitively recognizable text, for example, ‘send text’ (Writing command).

The NLI engine that configures a UI based on user-input information recognizes that the user intends to send the contents of the selected area in a text. Thereafter, the NLI engine further acquires necessary information by exchanging a question and an answer with the user, determining that information is insufficient for text sending. For example, the NLI engine asks the user to whom to send the text, for example, by ‘To whom?’.

The user inputs information about a recipient to receive the text by the memo function as an answer to the question. The name or phone number of the recipient may be directly input as the information about the recipient. In FIG. 11B, ‘Hwa Kyong-KIM’ and ‘Ju Yun-BAE” are input as recipient information.

The NLI engine detects phone numbers mapped to the input names ‘Hwa Kyong-KIM’ and ‘Ju Yun-BAE’ in a directory and sends text having the selected note contents as a text body to the phone numbers. If the selected note contents are an image, the user terminal may additionally convert the image to text so that the other party may recognize it.

Upon completion of the text sending, the NLI engine displays a notification indicating the processed result, for example, a message ‘text has been sent’. Therefore, the user can confirm that the process has been appropriately completed as intended.

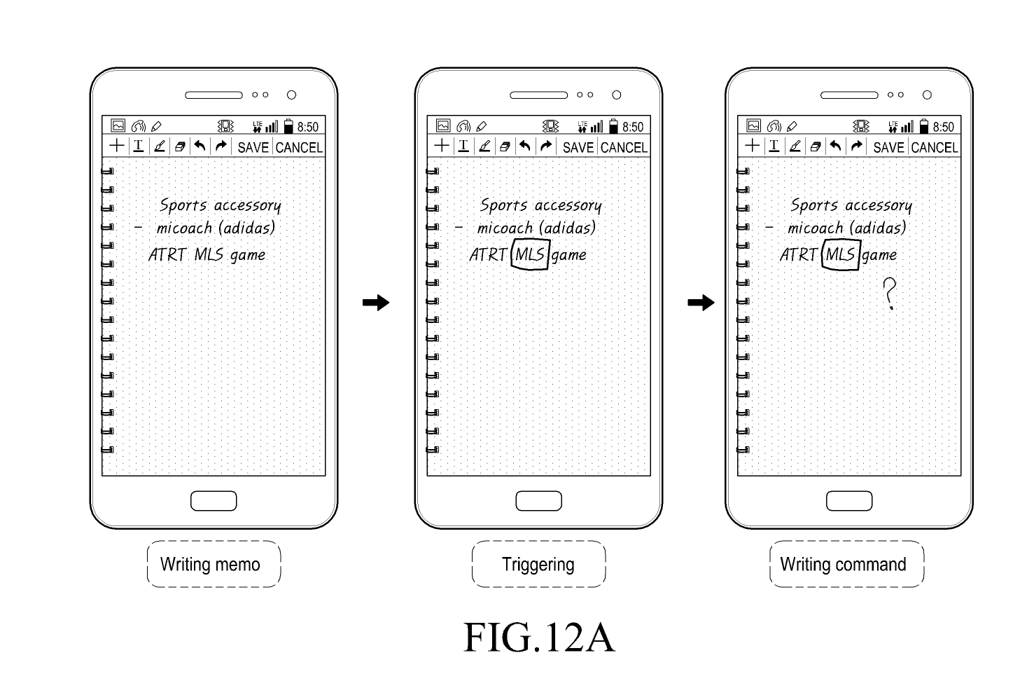

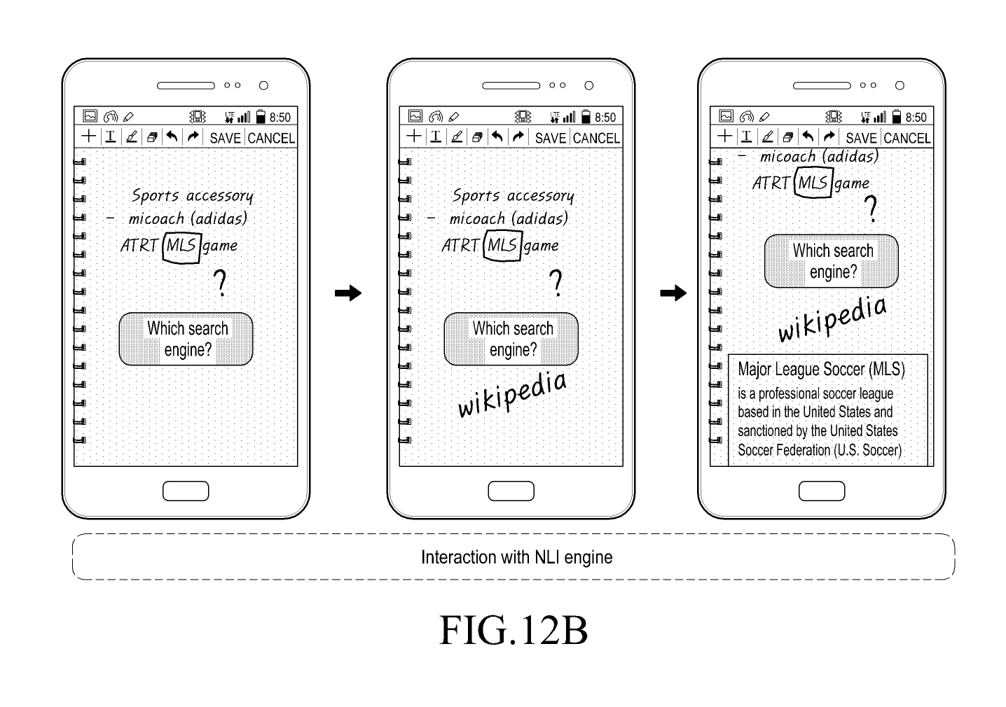

FIGS. 12A and 12B illustrate a scenario of finding the meaning of a part of a note by a memo function in a user terminal according to an exemplary embodiment of the present invention.

Referring to FIGS. 12A and 12B, the user writes a note on a screen by the memo function (Writing memo). Thereafter, the user selects a part of the note using a line, a symbol, a closed loop, and the like. (Triggering). For example, the user may select one word written in a partial area of the note by drawing a closed loop around the word.

The user requests the meaning of the selected text by writing a preset or an intuitively recognizable symbol, for example, ‘?’ (Writing command).

The NLI engine that configures a UI based on user-input information asks the user which engine to use in order to find the meaning of the selected word. For this purpose, the NLI engine uses a question and answer procedure with the user. For example, the NLI engine prompts the user to input information selecting a search engine by displaying ‘Which search engine?’ on the screen.

The user inputs ‘wikipedia’ as an answer by the memo function. Thus, the NLI engine recognizes that the user intends to use ‘wikipedia’ as a search engine using the user input as a keyword. The NLI engine finds the meaning of the selected word ‘MLS’ using ‘wikipedia’ and displays search results. Therefore, the user is aware of the meaning of the ‘MLS’ from the information displayed on the screen.

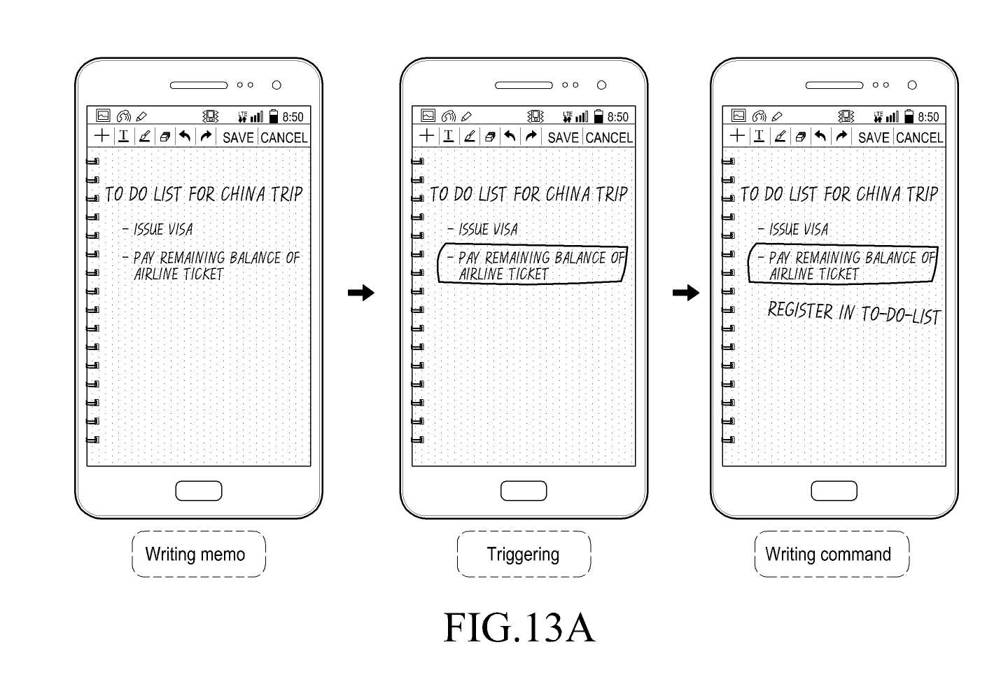

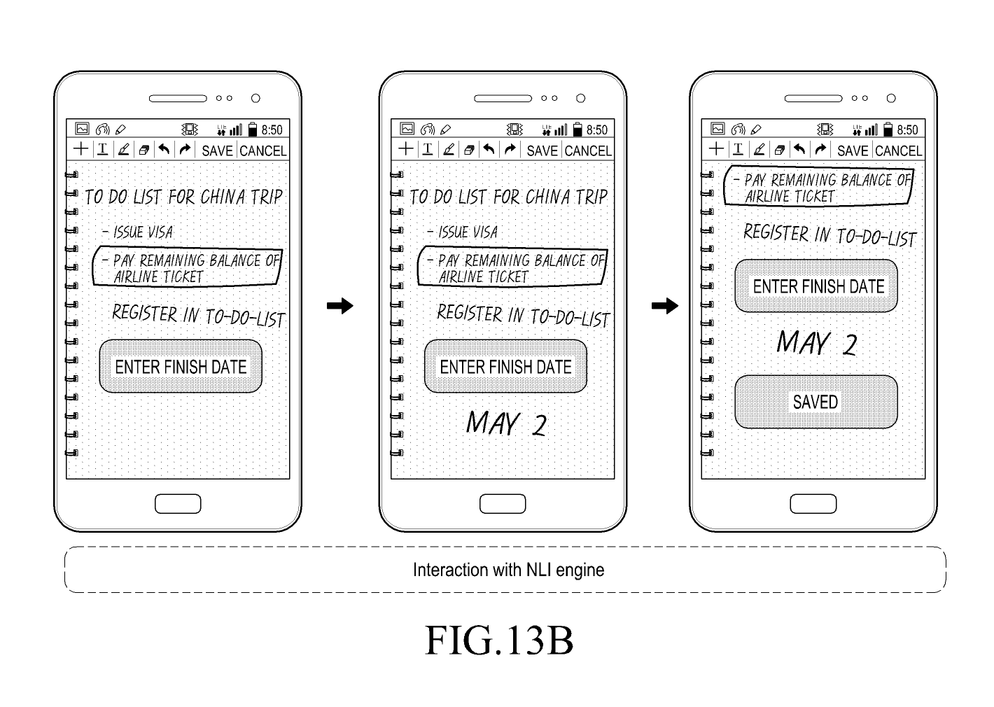

FIGS. 13A and 13B illustrate a scenario of registering a part of a note written by a memo function as information for another application in a user terminal according to an exemplary embodiment of the present invention.

Referring to FIGS. 13A and 13B, the user writes a to-do-list of things to prepare for a China trip on a screen of the user terminal by the memo function (Writing memo). Thereafter, the user selects a part of the note using a line, a symbol, a closed loop, and the like. (Triggering). For example, the user may select ‘pay remaining balance of airline ticket’ in a part of the note by drawing a closed loop around the text.

The user requests registration of the selected note contents in a to-do-list by writing a preset or an intuitively recognizable text, for example, ‘register in to-do-list’ (Writing command).

The NLI engine that configures a UI based on user-input information recognizes that the user intends to request scheduling of a task corresponding to the selected contents of the note. Thereafter, the NLI engine further acquires necessary information by a question and answer procedure with the user, determining that information is insufficient for scheduling. For example, the NLI engine prompts the user to input information by asking a schedule, for example, ‘Enter finish date’.

The user inputs ‘May 2’ as a date by which the task should be performed by the memo function as an answer. Thus, the NLI engine stores the selected contents as a thing to do by May 2.

After processing the user's request, the NLI engine displays the processed result, for example, a message ‘saved’. Therefore, the user is aware that an appropriate process has been performed as intended.

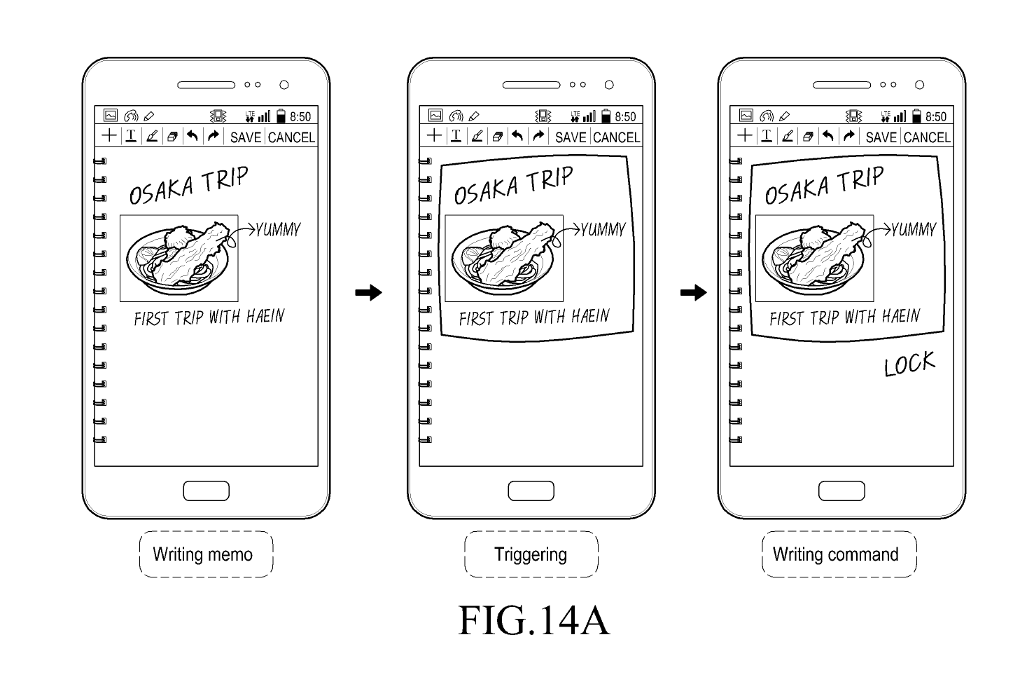

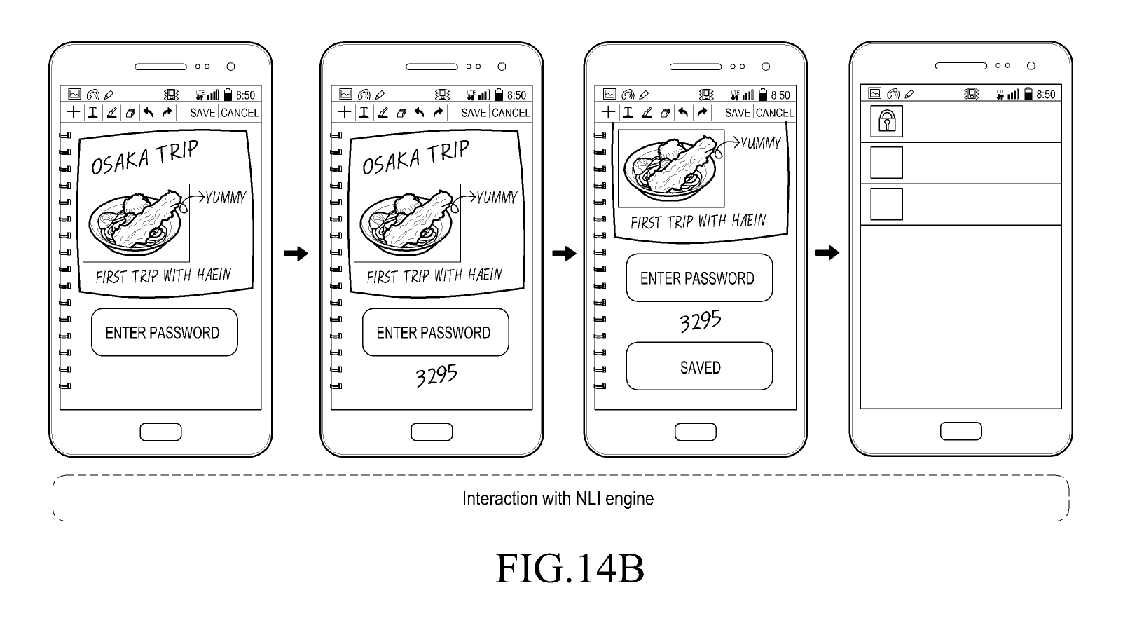

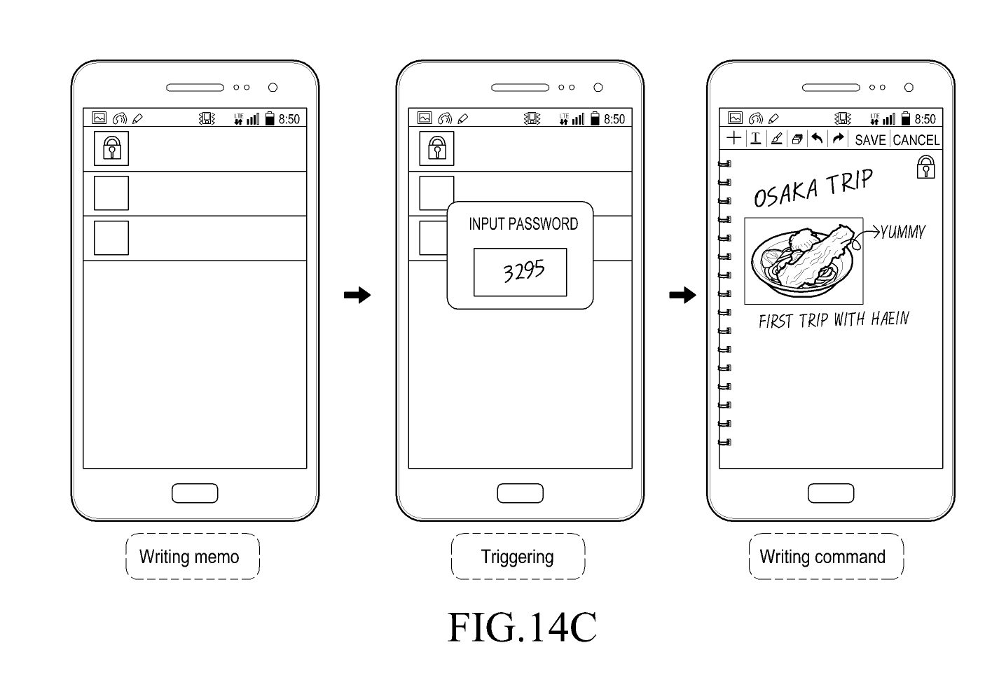

FIGS. 14A and 14B illustrate a scenario of storing a note written by a memo function using a lock function in a user terminal according to an exemplary embodiment of the present invention. FIG. 14C illustrates a scenario of reading a note stored by a lock function according to an exemplary embodiment of the present invention.

Referring to FIGS. 14A and 14B, the user writes the user's experiences during an Osaka trip using a photo and a note on a screen of the user terminal by the memo function (Writing memo). Thereafter, the user selects a whole or part of the note using a line, a symbol, a closed loop, and the like. (Triggering). For example, the user may select the whole note by drawing a closed loop around the note.

The user requests registration of the selected note contents by the lock function by writing a preset or an intuitively recognizable text, for example, ‘lock’ (Writing command).

The NLI engine that configures a UI based on user-input information recognizes that the user intends to store the contents of the note by the lock function. Thereafter, the NLI engine further acquires necessary information by a question and answer procedure with the user, determining that information is insufficient for setting the lock function. For example, the NLI displays a question asking a password, for example, a message ‘Enter password’ on the screen to set the lock function.

The user inputs ‘3295’ as the password by the memo function as an answer in order to set the lock function. Thus, the NLI engine stores the selected note contents using the password ‘3295’.

After storing the note contents by the lock function, the NLI engine displays the processed result, for example, a message ‘saved’. Therefore, the user is aware that an appropriate process has been performed as intended.

Referring to FIG. 14C, the user selects a note from among notes stored by the lock function (Selecting memo). Upon selection of a specific note by the user, the NLI engine prompts the user to enter the password by a question and answer procedure, determining that the password is needed to provide the selected note (Writing password). For example, the NLI engine displays a memo window in which the user may enter the password.

When the user enters the valid password, the NLI engine displays the selected note on a screen.

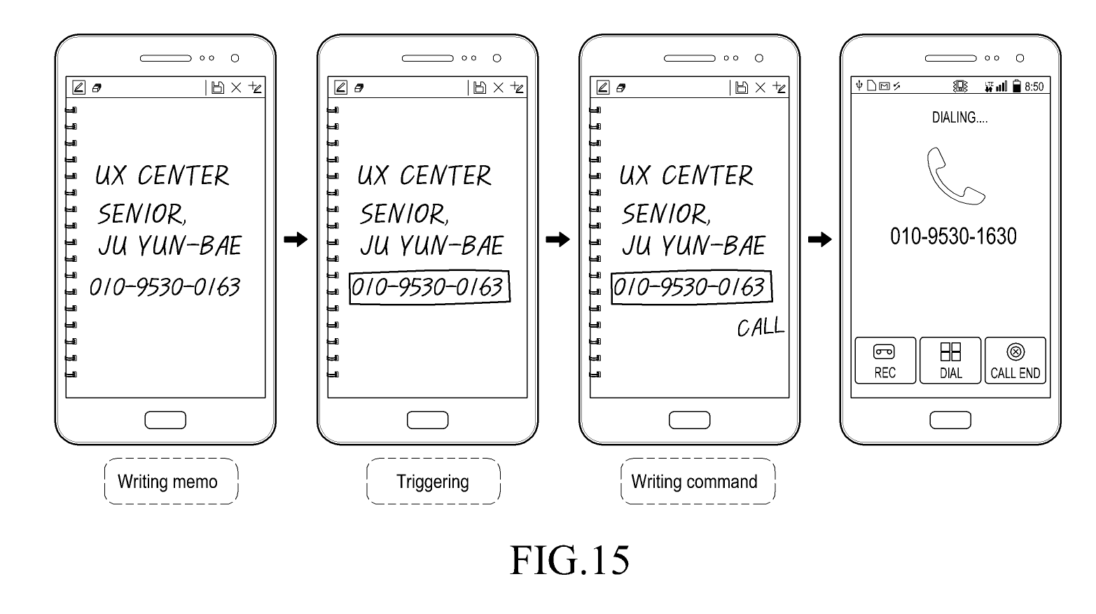

FIG. 15 illustrates a scenario of executing a specific function using a part of a note written by a memo function in a user terminal according to an exemplary embodiment of the present invention.

Referring to FIG. 15, the user writes a note on a screen of the user terminal by the memo function (Writing memo). Thereafter, the user selects a part of the note using a line, a symbol, a closed loop, and the like. (Triggering). For example, the user may select a phone number ‘010-9530-0163’ in the full note by drawing a closed loop around the phone number.

The user requests dialing of the phone number by writing a preset or an intuitively recognizable text, for example, ‘call’ (Writing command).

The NLI engine that configures a UI based on user-input information recognizes the selected phone number by translating it into a natural language and attempts to dial the phone number ‘010-9530-0163’.

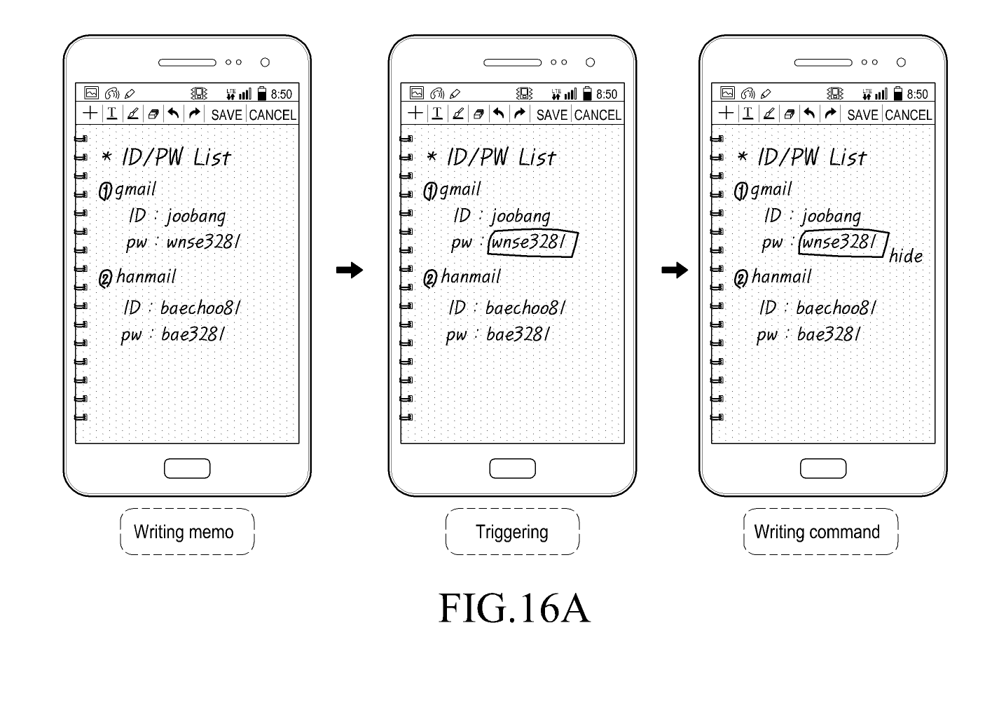

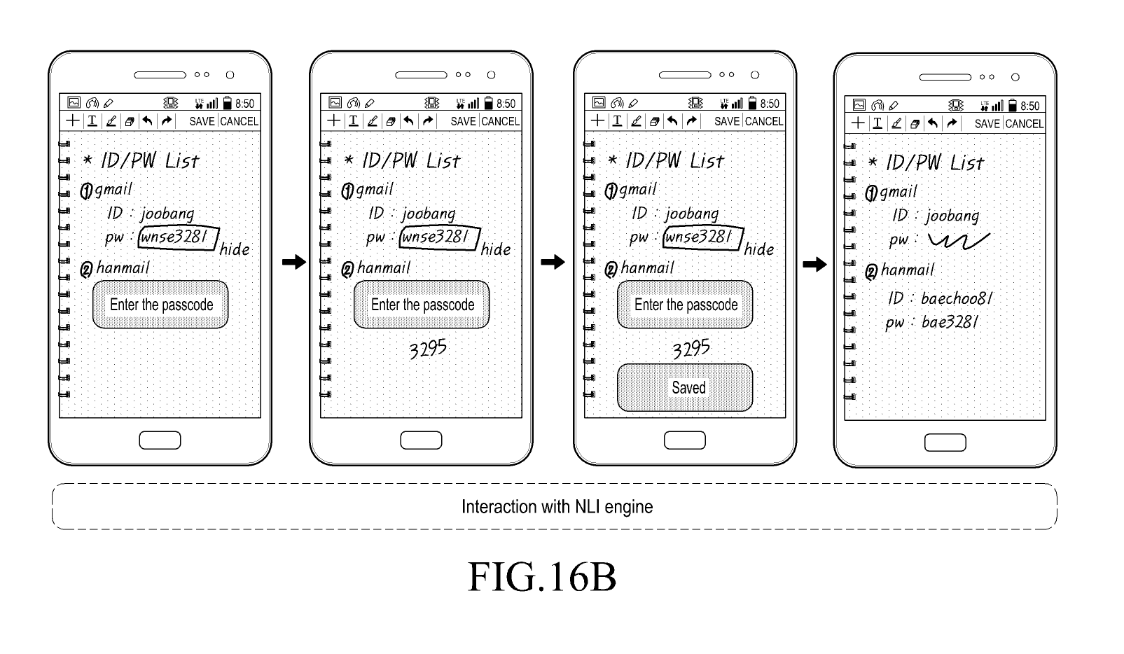

FIGS. 16A and 16B illustrate a scenario of hiding a part of a note written by a memo function in a user terminal according to an exemplary embodiment of the present invention.

Referring to FIGS. 16A and 16B, the user writes an ID and a password for each website that the user visits on a screen of the user terminal by the memo function (Writing memo). Thereafter, the user selects a whole or part of the note using a line, a symbol, a closed loop, and the like. (Triggering). For example, the user may select a password ‘wnse3281’ in the full note by drawing a closed loop around the password.

The user requests hiding of the selected contents by writing a preset or an intuitively recognizable text, for example, ‘hide’ (Writing command).

The NLI engine that configures a UI based on user-input information recognizes that the user intends to hide the selected note contents. To use a hiding function, the NLI engine further acquires necessary information from the user by a question and answer procedure, determining that additional information is needed. The NLI engine outputs a question asking the password, for example, a message ‘Enter the password’ to set the hiding function.

When the user writes ‘3295’ as the password by the memo function as an answer to set the hiding function, the NLI engine recognizes ‘3295’ by translating it into a natural language and stores ‘3295’. Thereafter, the NLI engine hides the selected note contents so that the password does not appear on the screen.

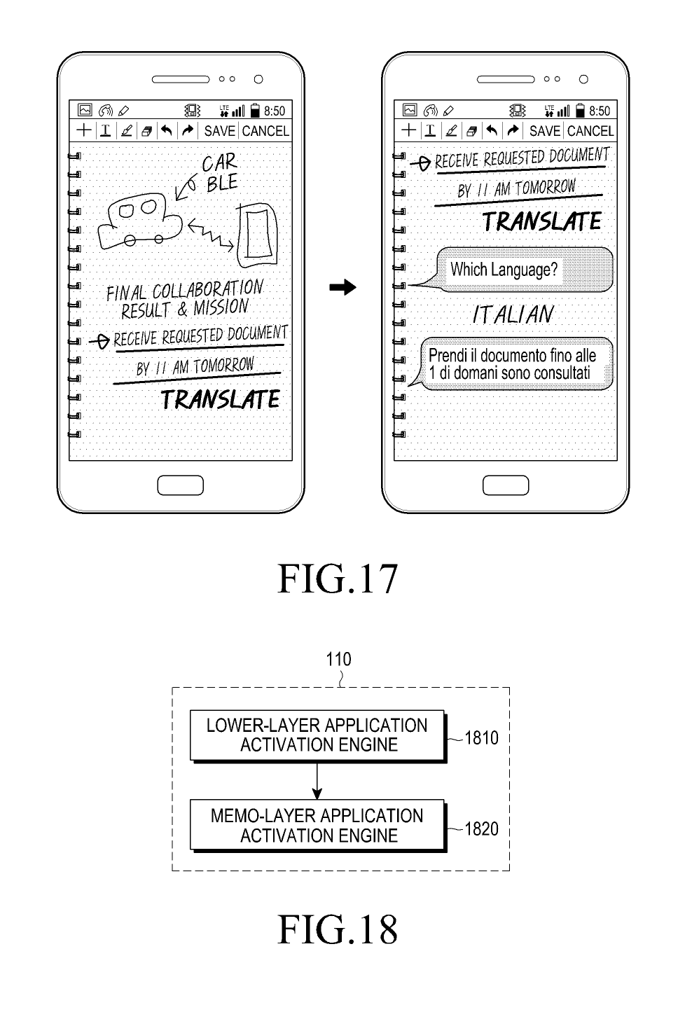

FIG. 17 illustrates a scenario of translating a part of a note written by a memo function in a user terminal according to an exemplary embodiment of the present invention.

Referring to FIG. 17, the user writes a note on a screen of the user terminal by the memo function (Writing memo). Thereafter, the user selects a part of the note using a line, a symbol, a closed loop, and the like. (Triggering). For example, the user may select a sentence ‘receive requested document by 11 AM tomorrow’ from the full note by underlining the sentence.

The user requests translation of the selected contents by writing a preset or an intuitively recognizable text, for example, ‘translate’ (Writing command).

The NLI engine that configures a UI based on user-input information recognizes that the user intends to request translation of the selected note contents. Thereafter, the NLI engine displays a question asking a language into which the selected note contents are to be translated by a question and answer procedure. For example, the NLI engine prompts the user to enter an intended language by displaying a message ‘Which language’ on the screen.

When the user writes ‘Italian’ as the language by the memo function as an answer, the NLI engine recognizes that ‘Italian’ is the user's intended language. Thereafter, the NLI engine translates the recognized note contents, that is, the sentence ‘receive requested document by 11 AM tomorrow’ into Italian and outputs the translation. Therefore, the user reads the Italian translation of the requested sentence on the screen.

FIG. 18 illustrates a configuration for controlling an activated application by a memo function in a user terminal according to an exemplary embodiment of the present invention. The configuration illustrated in FIG. 18 displays a memo layer over a screen of a currently executed specific application in an overlapped manner, recognizes a user's intention from a note written in the displayed memo layer, and controls an operation of the executed application according to the user's intention in the user terminal. The executed specific application will be referred to as ‘a lower-layer application’. Furthermore, overlapped display of the memo layer on the screen triggered by executing the lower-layer application implies that an application supporting the memo function is additionally executed.

Referring to FIG. 18, a lower-layer application activation engine 1810 executes a user-requested specific application, that is, a lower-layer application and provides overall control to the executed lower-layer application by recognizing the user's intention.

More particularly, when the user invokes the memo layer and issues an operation command by writing a note in the memo layer, the lower-layer application activation engine 1810 controls an operation of the executed lower-layer application according to the operation command.

For the purpose, the lower-layer application activation engine 1810 may provide specific information to a memo-layer application activation engine 1820 to indicate information required to control the operation of the executed lower-layer application at the moment, taking into account a function menu of the lower-layer application. The specific information includes at least one of the type of the lower-layer application and a function menu currently executed based on the lower-layer application.

In this case, the lower-layer application activation engine 1810 may receive more accurate information to control the operation of the currently executed lower-layer application.

The memo-layer application activation engine 1820 continuously monitors reception of a user input in a preset form agreed on to request execution of an application supporting a memo function. For example, the preset form may be a touch and drag on the execution screen of the lower-layer application. The touch and drag may be directed to the right, to the left, upward or downward on the screen. Any recognizable tool may be used to make the touch and drag. The tool may be mainly a finger or an electronic pen.

Upon receipt of a request for execution of the application supporting the memo function from the user, the memo-layer application activation engine 1820 invokes the memo layer that allows the user to write a note. The invoked memo layer overlaps with the execution screen of the lower-layer application.

Preferably, the memo layer is overlapped with the execution screen of the lower-layer application in such a manner that the execution screen of the lower-layer application shows through the memo layer. An area in which the memo layer is overlapped with the screen may be set by a user request. For example, the memo layer may be overlapped fully or partially with the screen according to a setting. Alternatively, after the memo layer is overlapped partially with the screen, the user may change the size of the memo layer by selecting and dragging the outline or a vertex of the memo layer.

As described above, the memo-layer application activation engine 1820 controls an overall operation for displaying the memo layer to allow a user to write a note, upon a user request, while the lower-layer application is being executed.

If the lower-layer application activation engine 1810 indicates information required to control the lower-layer application, the memo-layer application activation engine 1820 further displays ‘a message notifying information that a user is to input’. For example, if a music play application is being executed as the lower-layer application, a message ‘Enter the title of a song’ or ‘Enter an artist name’ is displayed in the memo layer.

After displaying the memo layer on the screen, the memo-layer application activation engine 1820 recognizes the user's intention based on a note written by the user. Thereafter, the memo-layer application activation engine 1820 provides control information related to activation of the lower-layer application as intended by the user to the lower-layer application activation engine 1810.

To recognize completion of a handwriting note, the memo-layer application activation engine 1820 may further display an input menu button in the displayed memo layer. In this case, when the user presses the input menu button, the memo-layer application activation engine 1820 starts to perform an operation for recognizing the user's intention based on the contents of the note written in the memo layer.

Recognition of a user's intention based on a note written in a memo layer and control of an operation of an associated application according to the recognized user's intention have been described above. Therefore, the description is also applicable in regard to the user's intention recognition and the operation control. Hence, a redundant description of the user's intention recognition and the operation control will be avoided herein.

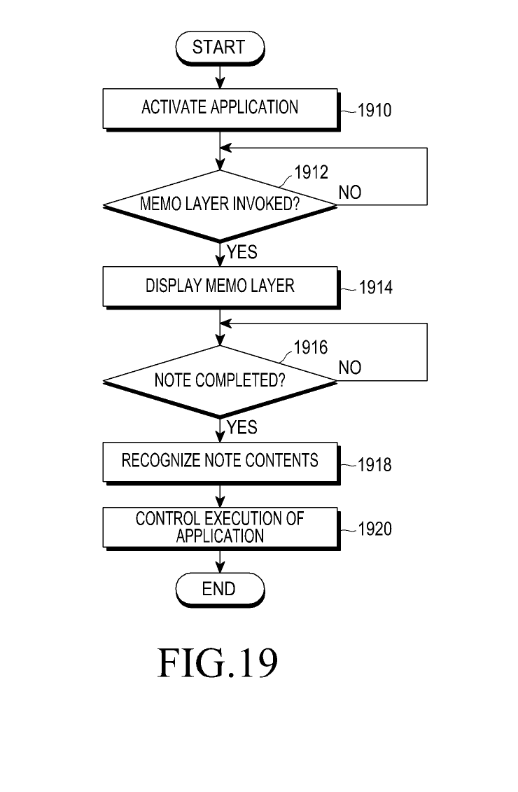

FIG. 19 is a flowchart illustrating a control operation for controlling a lower-layer application by invoking a memo layer in a user terminal according to an exemplary embodiment of the present invention.

Referring to FIG. 19, the user terminal activates a specific application, that is, a lower-layer application, upon a user request in step 1910. After activating the lower-layer application, the user terminal controls an overall operation regarding the activated lower-layer application. The user terminal displays an operation state of the lower-layer application on a screen so that the user may identify the operation state of the lower-layer application.

While the lower-layer application is being executed, the user terminal continuously monitors whether the user has invoked a memo layer in step 1912. For example, when the user touches an execution screen of the lower-layer application and drags the touch on the screen, the user terminal invokes the memo layer. The touch and drag may be directed to the right, to the left, upward, or downward. Any recognizable tool may be used to make the touch and drag. The tool may be mainly a user's finger or an electronic pen.

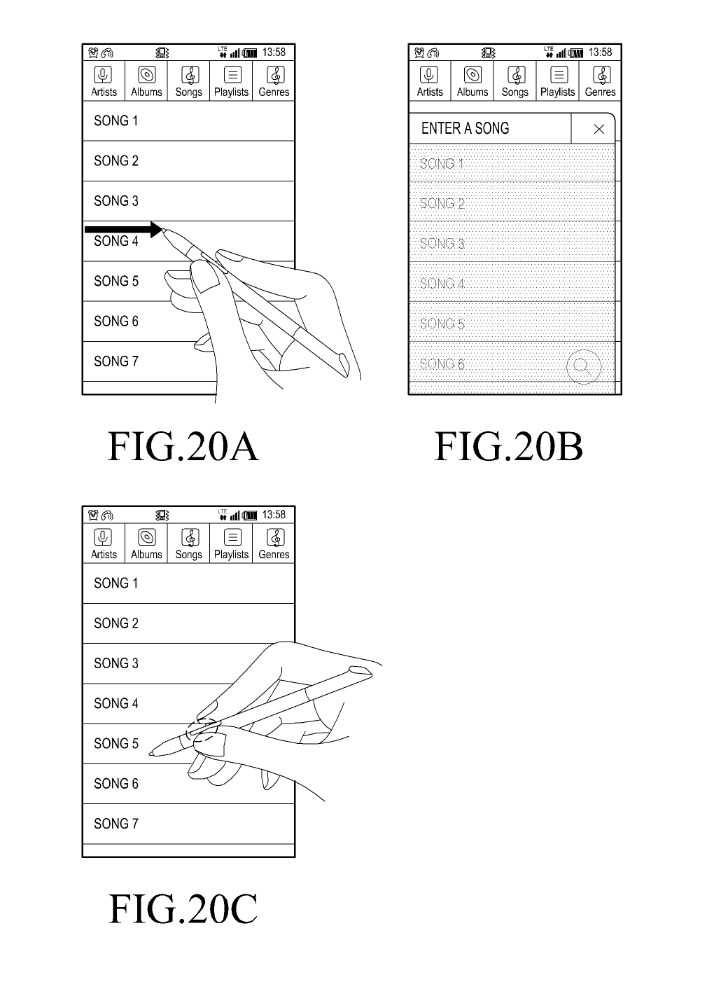

FIGS. 20A through 20C illustrate operations of invoking a memo layer in a user terminal according to an exemplary embodiment of the present invention.

Referring to FIG. 20A, when the user touches a screen in which a function menu supporting a playlist is activated in a music play application and drags the touch from left to right (refer to FIG. 20A), the menu layer is invoked, by way of example.

Alternatively, when the user approaches a preset range of the screen in which the function menu supporting a playlist is activated in the music play application (a hovering function), pressing a function button of an electronic pen (refer to FIG. 20C), the menu layer may be invoked.

Referring back to FIG. 19, the user terminal displays the memo layer invoked by the user request over the execution screen of the lower-layer application in step 1914. The user terminal may further display ‘a message indicating information to be input by a user’ in the memo layer displayed on the screen.

Referring to FIG. 20B, for example, the invoked menu layer is overlapped with the screen displaying the activated function menu supporting a playlist in the music play application in such a manner that the screen shows through the overlying menu layer. In FIG. 20B, a message ‘Enter a song title!’ is displayed in the memo layer.

While not shown, the user terminal may set an area in which the memo layer is overlapped, upon a user request. For example, the memo layer may be fully or partially overlapped with the screen. The size of the memo layer may be changed by selecting and dragging the outline or a vertex of the memo layer displayed in a part of the screen.

The user terminal determines whether the user has finished writing a note in the displayed memo layer in step 1916. For example, an ‘input menu button’ may further be displayed in the memo layer so that a decision is made as to whether the user has finished writing a memo by determining whether the input menu button has been pressed.

Referring to FIG. 20B, an icon representing a search function is displayed as the input menu button at the lower right-hand corner of the screen displaying the memo layer.

However, it is to be clearly understood that the input menu button is changed according to information input to the memo layer, not limited to the icon representing a search function.

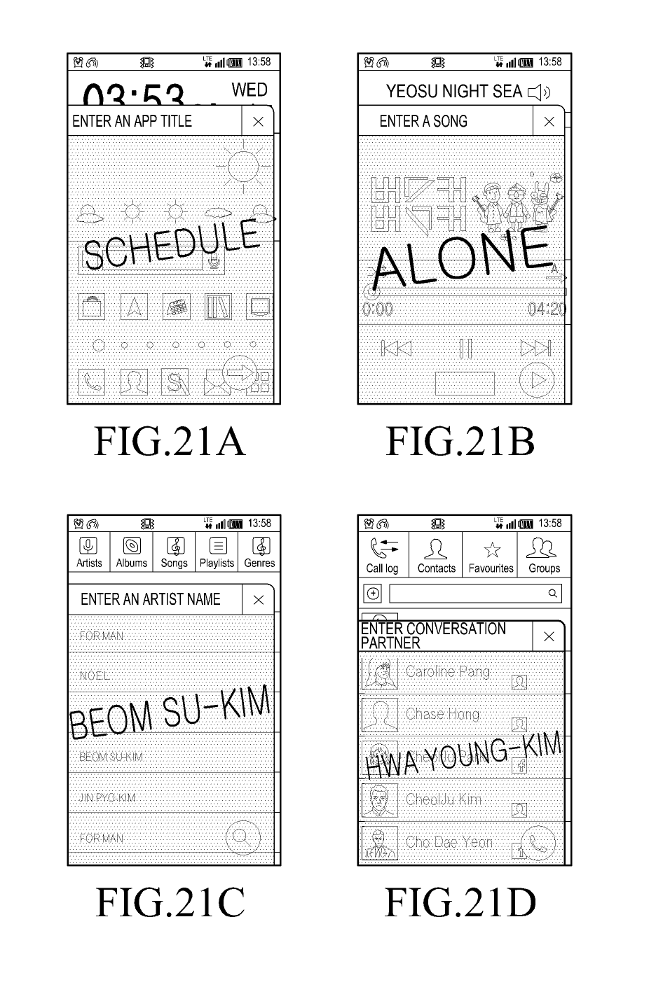

FIGS. 21A through 21D illustrate a user writing a note on a memo layer displayed on a screen in a user terminal according to an exemplary embodiment of the present invention.

Referring to FIG. 21A, a memo layer is displayed, which includes a title ‘Enter an application name’ and a menu execution button representing an execution related to the application name. The user writes ‘schedule’ in the displayed memo layer. When the user presses the menu execution button corresponding to an application execution request in the memo layer, the user terminal executes a scheduler application.

Referring to FIG. 21B, a memo layer is displayed, which includes a title ‘Enter a song’ and a menu execution button representing an execution related to the title. The user writes ‘Alone’ in the displayed memo layer. When the user presses the menu execution button corresponding to a music play request in the memo layer, the user terminal searches for the song ‘Alone’ and plays back the detected song.

Referring to FIG. 21C, a memo layer is displayed, which includes a title ‘Enter an artist name’ and a menu execution button representing an execution related to the title. The user writes ‘Beom Su-KIM’ in the displayed memo layer. When the user presses the menu execution button corresponding to a search request in the memo layer, the user terminal searches for songs or albums sung by ‘Beom Su-KIM’ and displays the search results.

Referring to FIG. 21D, a memo layer is displayed, which includes a title ‘Enter a called party's name’ and a menu execution button representing an execution related to the title. The user writes ‘Ha Young-KIM’ in the displayed memo layer. When the user presses the menu execution button corresponding to a dial request in the memo layer, the user terminal attempts to dial a phone number listed for ‘Ha young-KIM’ in a contact list being executed as a lower-layer application.

Upon detecting completion of the note, the user terminal recognizes the user's intention based on the note written in the memo layer displayed on the screen in step 1918. Thereafter, the user terminal controls an operation of the currently executed lower-layer application according to the recognized user's intention in step 1920.

While the above description is based on the assumption that a screen triggered by activation of a lower-layer application has already been displayed, it may be further contemplated as an alternative exemplary embodiment that a menu layer is displayed on a home screen with no application executed on it, upon a user request, and a user-intended operation is performed based on information handwritten in the displayed menu layer.

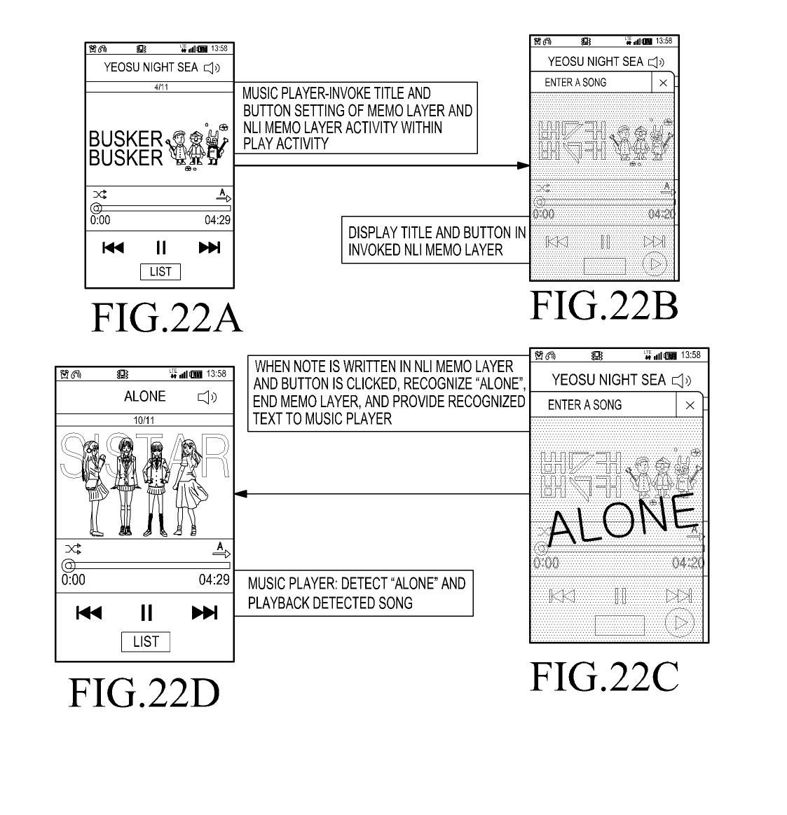

FIGS. 22A through 22D illustrate controlling of a currently executed specific application using a memo layer in a user terminal according to an exemplary embodiment of the present invention.

Referring to FIGS. 22A through 22D, while a music play application is being executed as a lower-layer application, the user terminal monitors whether the user has invoked a memo layer (see FIG. 22A). When the user invokes the memo layer, the user terminal activates a menu layer having a title and an input menu button set in it on a screen. For example, the menu layer having the title and the input menu button set in it is displayed over an execution screen of the music play application (see FIG. 22B). In FIG. 22B, the title of the memo layer is shown as ‘Enter a song!’.

The user terminal monitors whether the UE has written a note (e.g., ‘Alone’) and pressed the displayed input menu button. Upon detecting the user pressing of the input menu button, the user terminal recognizes the note as ‘Alone’ and provides the recognized text ‘Alone’ to the currently executed music play application (see FIG. 2C).

The music play application searches for a song having the received title ‘Alone’ and plays the detected song. A search range may be set by a user setting. For example, the search range may be songs stored in the user terminal or a website that provides a music service. To set the website as a search range, information required for authentication to access the website needs to be managed by the user terminal or input by the user.

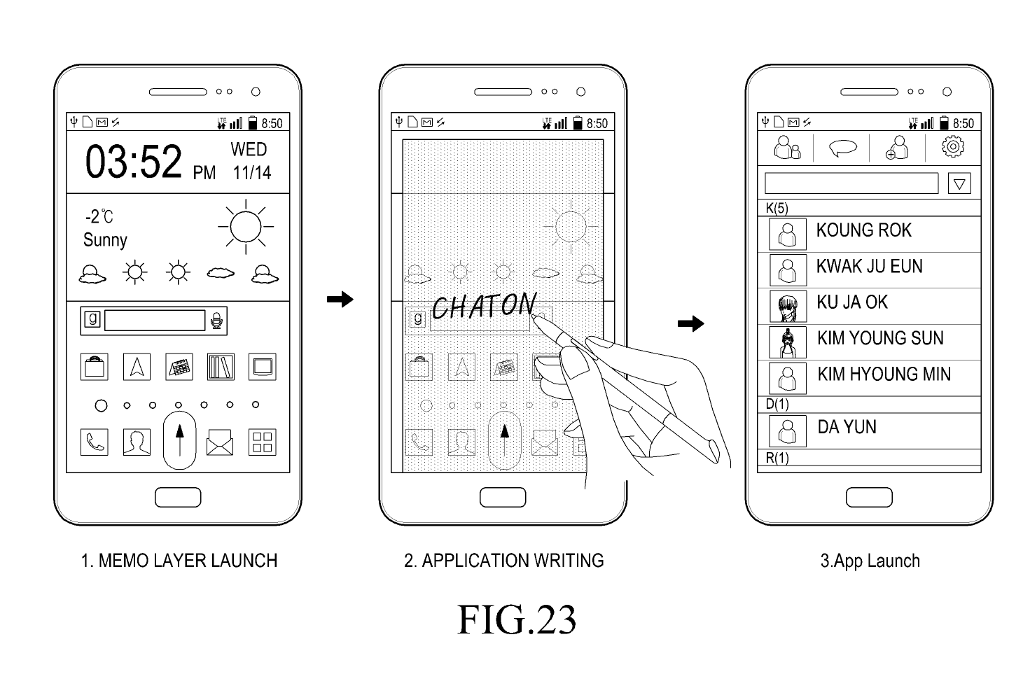

If a plurality of search results match ‘Alone’, a plurality of songs corresponding to the search results may be played sequentially or the user is prompted to select one of the songs. For example, the search results are preferably displayed in the form of a list on a screen so that the user may select a song from the list. FIGS. 23 through 28 illustrate exemplary scenarios in which after a specific application is activated, another application supporting a memo function is launched and the activated application is executed by the launched application.

FIG. 23 illustrates a scenario of executing a memo layer on a home screen of a user terminal and executing a specific application on a memo layer according to an exemplary embodiment of the present invention.

Referring to FIG. 23, a user terminal launches a memo layer on the home screen by executing a memo application on the home screen and executes an application, upon receipt of identification information about the application (e.g., the name of the application) ‘Chaton’.

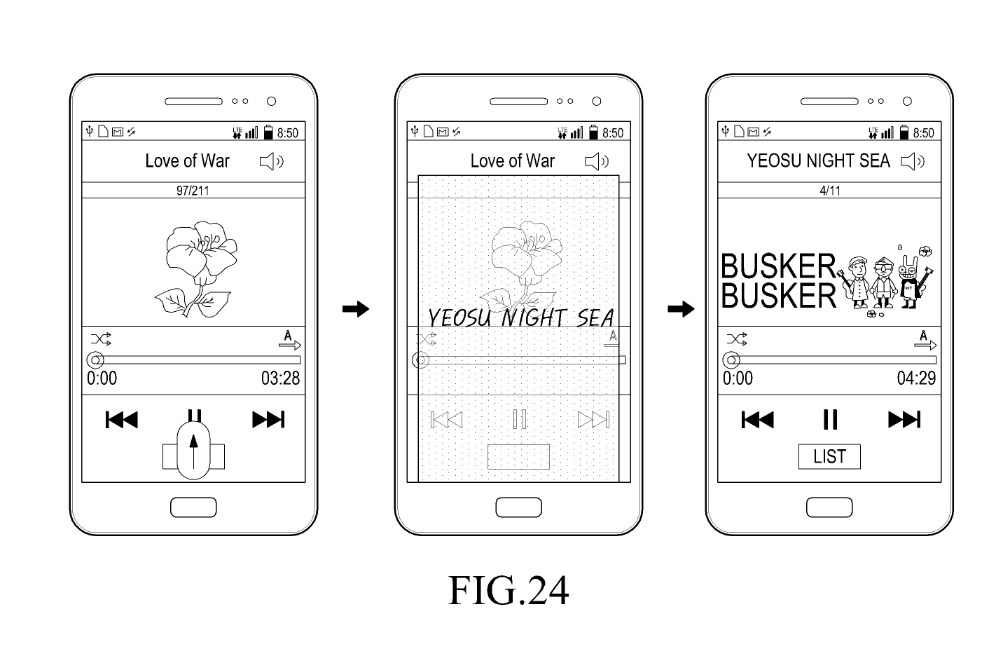

FIG. 24 illustrates a scenario of controlling a specific operation in a specific active application by a memo function in a user terminal according to an exemplary embodiment of the present invention.

Referring to FIG. 24, a memo layer is launched by executing a memo application on a screen on which a music play application has already been executed. Thereafter, when the user writes the title of an intended song, ‘Yeosu Night Sea” on the screen, the user terminal plays back a sound source corresponding to ‘Yeosu Night Sea’ in the active application.

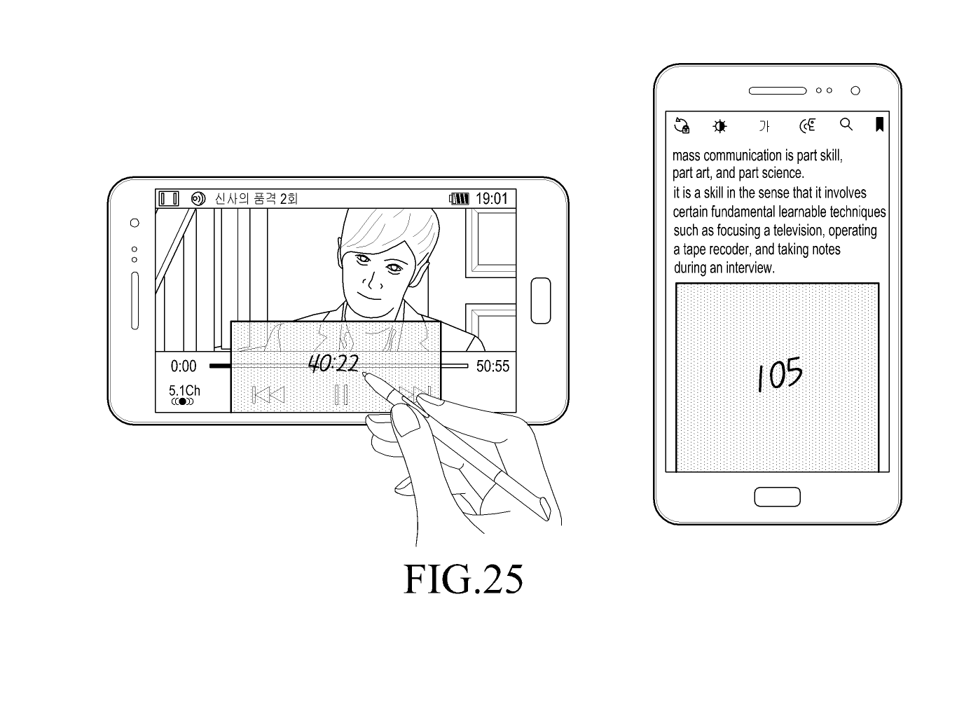

FIG. 25 illustrates scenarios of controlling a specific active application by a memo function in a user terminal according to an exemplary embodiment of the present invention.

Referring to FIG. 25, if the user writes a time to jump to, ‘40:22’ on a memo layer during viewing a video, the user terminal jumps to a time point of 40 minutes 22 seconds to play the on-going video. This function may be performed in the same manner during listening to music as well as during viewing a video.

When the user launches a memo layer during execution of an e-book reader application and writes a page to jump to, for example, ‘105’ on the memo layer, the user terminal jumps to page 105 of a book that the user is reading.

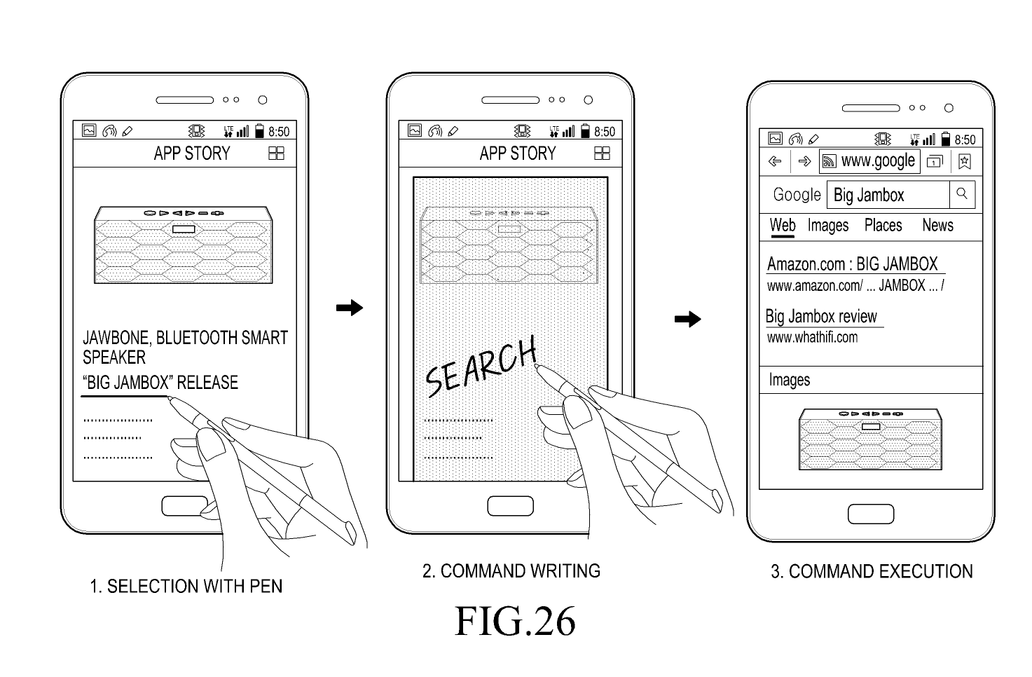

FIG. 26 illustrates a scenario of attempting a search using a memo function, while a Web browser is being executed in a user terminal according to an exemplary embodiment of the present invention.

Referring to FIG. 26, while reading a specific Web page using a Web browser, the user selects a part of contents displayed on a screen, launches a memo layer, and writes a word ‘search’ on the memo layer, thereby commanding a search using the selected contents as a keyword. The NLI engine recognizes the user's intention and understands the selected contents through a natural language process. Thereafter, the NLI engine searches using a set search engine using the selected contents and displays search results on the screen.

As described above, it may be further contemplated that the user terminal processes contents selection and memo function-based information input together on a screen that provides a specific application.

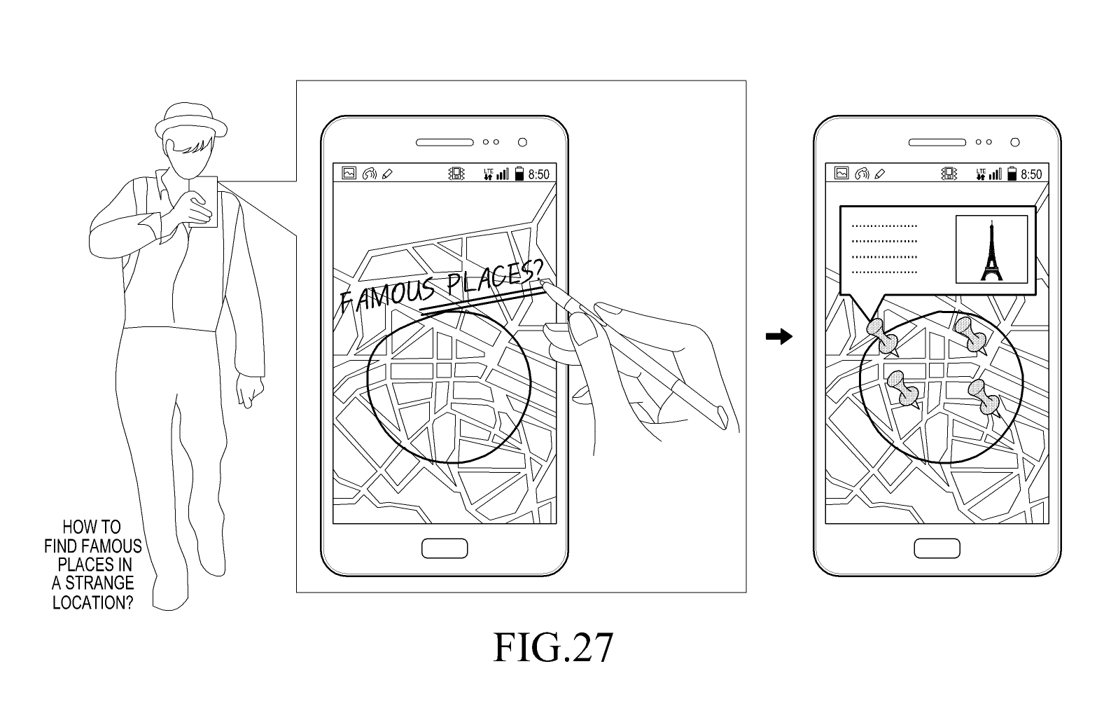

FIG. 27 illustrates a scenario of acquiring intended information in a map application by a memo function according to an exemplary embodiment of the present invention.

Referring to FIG. 27, the user selects a specific area by drawing a closed loop around the area on a screen of a map application using the memo function and writes information to search for, for example, ‘famous places?’, thereby commanding search for famous places within the selected area.

When recognizing the user's intention, the NLI engine of the user terminal searches for useful information in its preserved database or a database of a server and additionally displays detected information on the map displayed on the current screen.

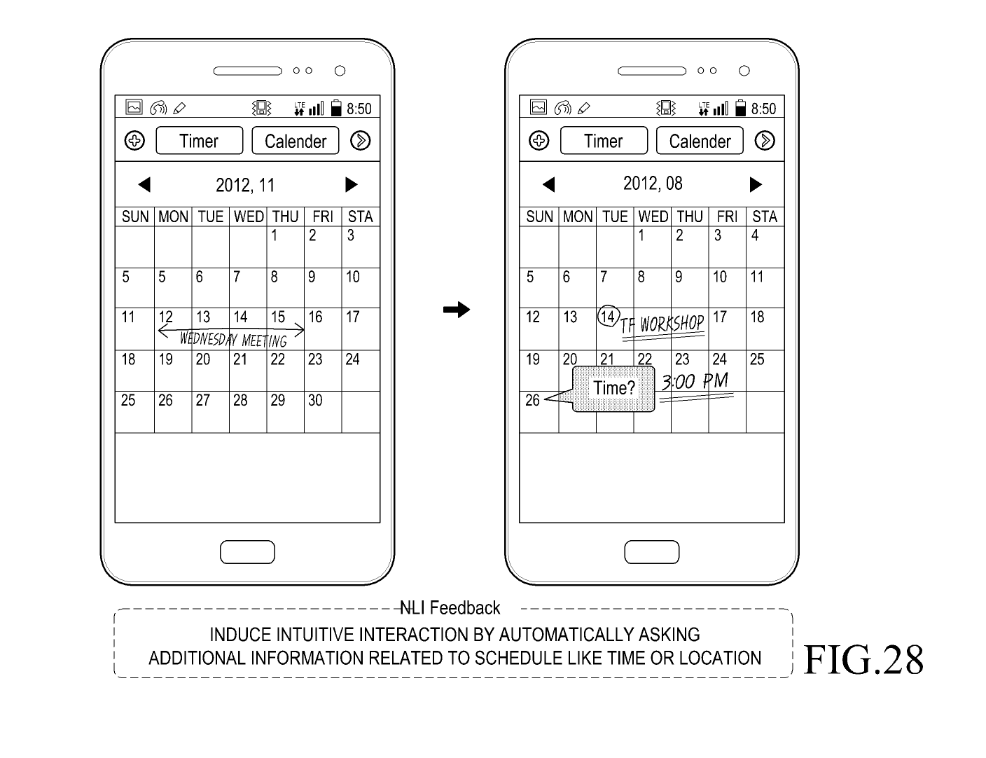

FIG. 28 illustrates a scenario of inputting intended information by a memo function, while a scheduler application is being activated according to an exemplary embodiment of the present invention.

Referring to FIG. 28, while the scheduler application is being activated, the user executes the memo function and writes information on a screen, as is done offline intuitively. For instance, the user selects a specific date by drawing a closed loop on a scheduler screen and writes a plan for the date. For example, the user selects Aug. 14, 2012 and writes ‘TF workshop’ for the date. Thereafter, the NLI engine of the user terminal requests input of time as additional information. For example, the NLI engine displays a question ‘Time?’ on the screen so as to prompt the user to write an accurate time, such as ‘3:00 PM’, by the memo function.

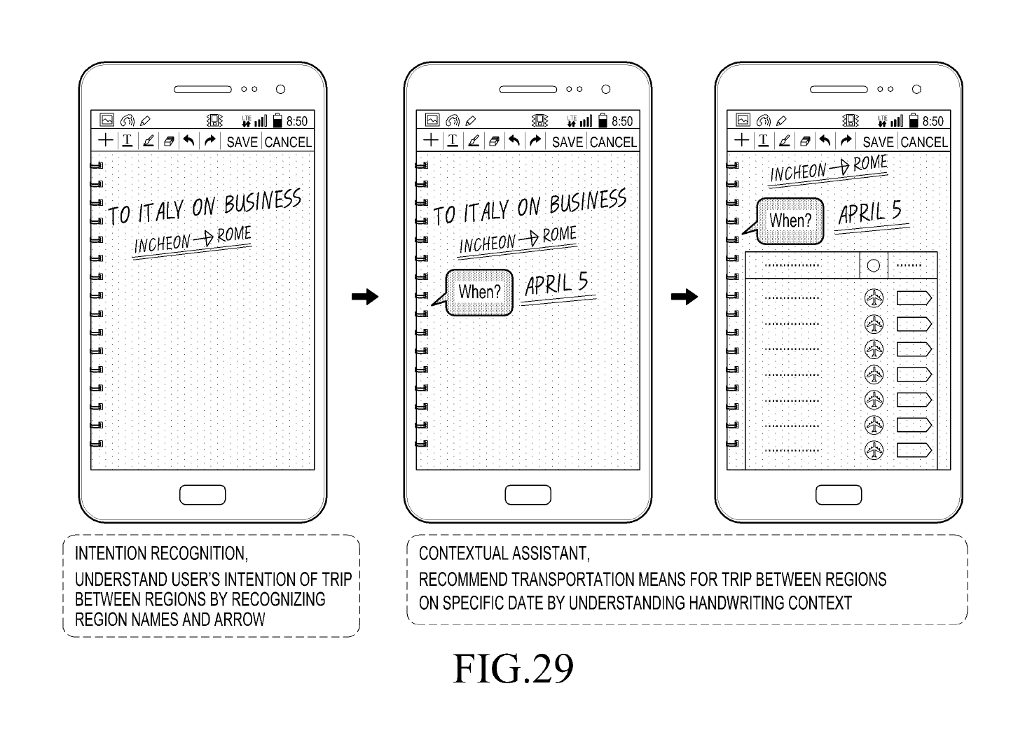

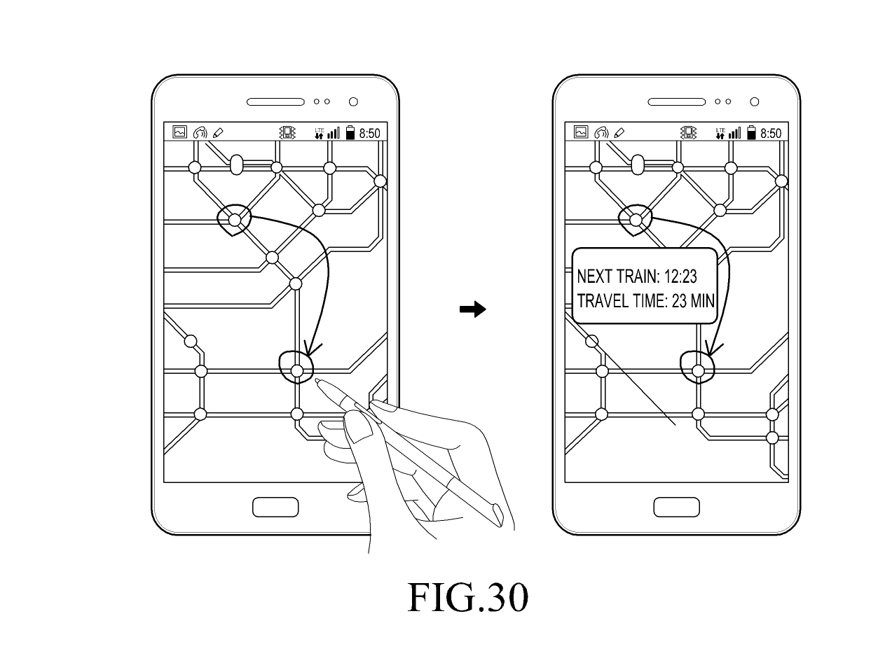

FIGS. 29 and 30 illustrate scenarios related to semiotics according to exemplary embodiments of the present invention.

Referring to FIG. 29, it illustrates an example of interpreting the meaning of a handwritten symbol in the context of a question and answer flow made by the memo function. For example, it may be assumed that both notes ‘to Italy on business’ and ‘Incheon→Rome’ are written. Since the symbol → may be interpreted as trip from one place to another, the NLI engine of the user terminal outputs a question asking time, for example, ‘When?’, to the user.

Furthermore, the NLI engine may search for information about flights available for the trip from Incheon to Rome on a user-written date, April 5 and provide search results to the user.

Referring to FIG. 30, it illustrates an example of interpreting the meaning of a symbol written by the memo function in conjunction with an active application.

For example, when the user selects a departure and a destination using a symbol, that is, an arrow in an intuitive manner on a screen on which a subway application is being activated. Thereafter, the user terminal may provide information about the arrival time of a train heading for the destination and a time taken to reach the destination by the currently activated application.

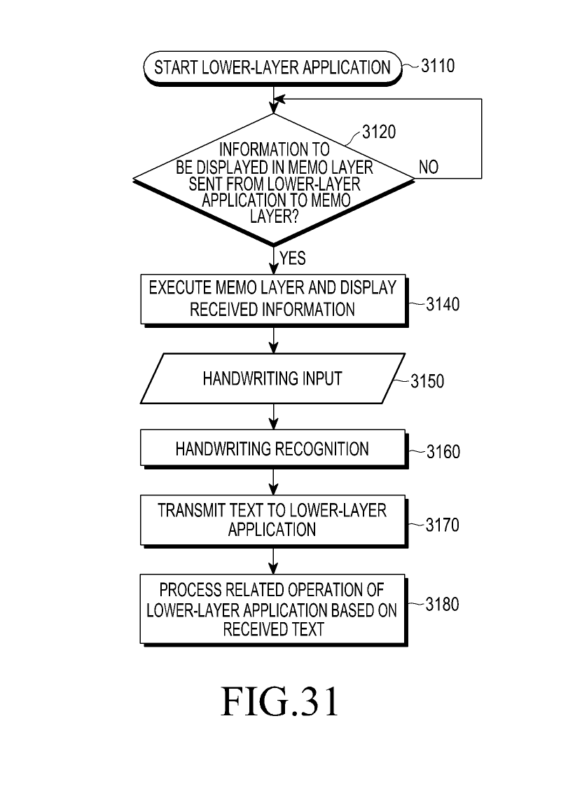

FIG. 31 is a flowchart illustrating a control operation for controlling a lower-layer application by invoking a memo layer in a user terminal according to another exemplary embodiment of the present invention.

Referring to FIG. 31, when the user starts a lower-layer application in step 3110, the controller determines whether the lower-layer application has transmitted information to be displayed in a memo layer to the memo layer. The memo layer may be a different application. The memo layer may be displayed in the form of a window on the touch panel. The following description will be given with the appreciation that the term ‘memo window’ is interchangeably used with the term ‘memo layer’.

The controller determines whether a predefined gesture has been created on the touch panel during execution of the lower-layer application in progress. The controller may provide overall control to the operation of the electronic device. The application executer 110 and the command processor 120 illustrated in FIG. 1 may collectively form the controller. The predefined gesture may be a touch and drag on the touch panel made by means of a user's finger or an electronic pen. Alternatively, the predefined gesture may be to draw a specific shape or pattern on the touch panel with a user's finger or an electronic pen. Upon detection of the predefined gesture during execution of the lower-layer application in progress, the controller may invoke the memo layer.

When the user touches a specific area of the touch panel during execution of the lower-layer application in progress, the controller may invoke the memo layer. The memo layer may be activated by a different application. Furthermore, the memo layer may be a software module incorporated into the lower-layer application.

Information requesting a user input may be displayed in the memo layer. The lower-layer application may transmit information to be displayed in the memo layer to the memo layer in step 3120.

When the memo layer is invoked, the information received from the lower-layer application may be displayed in the memo layer in step 3140. The memo layer may include a title area in which the title of the memo layer is displayed. The memo layer may further include a handwriting input area and a button that can be manipulated by the user. When the user writes a note in the memo layer in step 3150, the controller may recognize the handwriting image of the note in step 3160 and may transmit text corresponding to the recognized handwriting image to the lower-layer application in step 3170. The lower-layer application compares the received text with its managed commands. If the text received from the memo window fully or partially matches a managed command, the lower-layer application may perform an operation related to the command in step 3180.

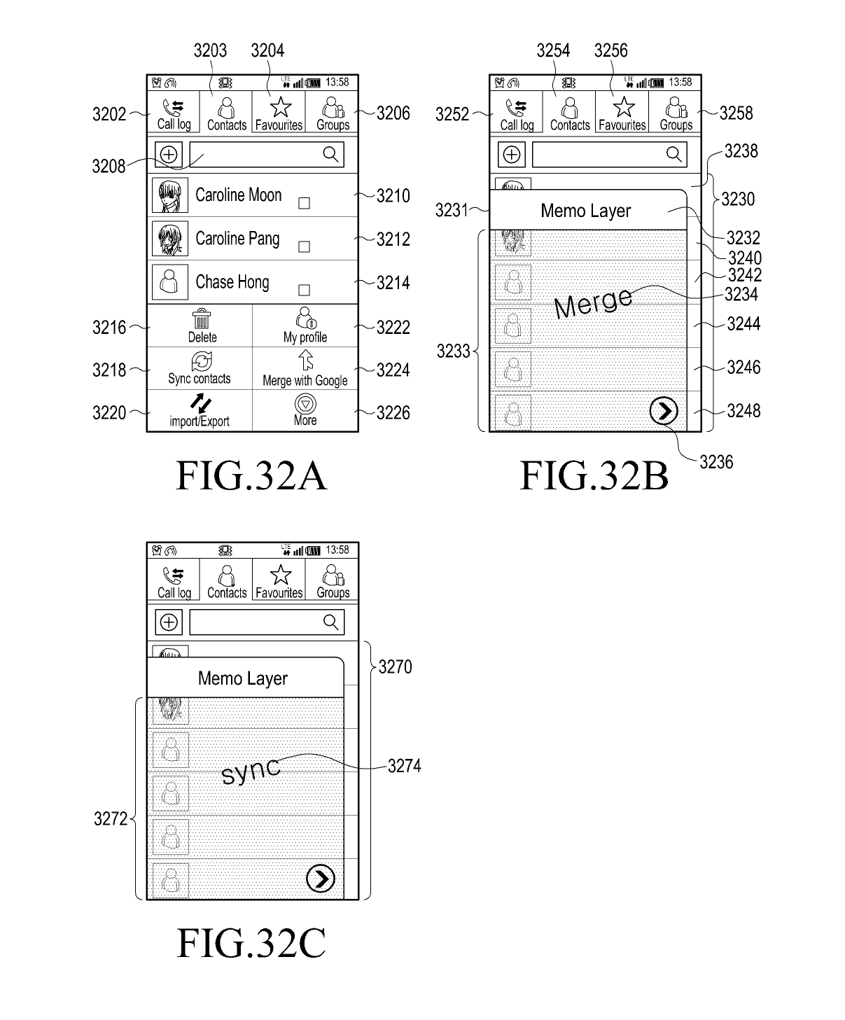

FIGS. 32A through 32C illustrate an operation for executing a memo layer during execution of a lower-layer application in progress according to an exemplary embodiment of the present invention. The memo layer may be a separate layer displayed over a layer in which the application is displayed. The memo layer may be a memo window. In the following description, the memo layer may be referred to as the memo window.

In the following description, a touch input refers to a touch on a graphic object displayed on the touch panel and a handwriting input refers to writing a character with an electronic pen or a finger.

Referring to FIG. 32A, a currently executed application is displayed on the touch panel in the electronic device. When an application is executed, the controller may display a graphic object representing information about the executed application and a menu item for controlling a function of the application on the touch panel. The menu item may take the form of a button. The user may perform the function of the application by touching the menu item. Upon detection of a touch on the menu item, the controller may control the function of the application corresponding to the menu item.

For example, when a directory application is executed, a graphic object related to the directory application and menu items 3216, 3218, 3220, 3222, 3224, and 3226 for controlling functions of the directory application are displayed on the touch panel. The directory application includes a first menu area, a search window 3208, directory items 3210, 3212, and 3214, and a second menu area. The first menu area may include four menu items 3202, 3203, 3204, and 3206. Each of the menu items 3202, 3203, 3204, and 3206 include an icon representing the menu item and a menu name. For example, the menu item 3202 includes a phone receiver-shaped icon and text Call Log. The menu item 3203 includes a human-shaped icon and text Contacts. When the user touches one of the menu items 3202, 3203, 3204, and 3206, the touched menu item may be changed to a different color. As the menu item is selected, contents of the directory items may be changed. For example, the directory items 3210, 3212, and 3214 may be changed. The menu items 3216, 3218, 3220, 3222, 3224, and 3226 may be displayed in the second menu area. Upon detection of a touch on one of the menu items 3216, 3218, 3220, 3222, 3224, and 3226, the controller may control a function of the application corresponding to the touched menu item.

For example, the menu item 3216 may include a wastebasket icon and a command ‘Delete’. Upon selection one of the menu items 3216, 3218, 3220, 3222, 3224, and 3226, a command corresponding to the selected menu item may be executed for the directory items 3210, 3212, and 3214. If the menu item 3216 is selected, the directory items 3210, 3212, and 3214 may be synchronized with another directory. If the menu item 3224 is selected, a directory item selected from among the directory items 3210, 3212, and 3214 may be merged with information about the same person listed in another directory.

The second menu area may be displayed over the directory items 3210, 3212, and 3214. Six directory items are initially displayed on the touch panel. As the second menu area is displayed on the touch panel, the three directory items 3210, 3212, and 3214 out of the six directory items are displayed on the touch panel, while the other directory items (not shown) are hidden behind the second menu area.

Referring to FIG. 32B, first menu items 3252, 3254, 3256, and 3258 are displayed on the touch panel. A directory area 3230 may further be displayed on the touch panel. The directory area 3230 may include a plurality of directory items. A command may be executed for the directory items. For example, the directory items may be used as data when a command is executed. When the user touches one of directory items 3238, 3240, 3242, 3244, 3246, and 3248, the touched directory item is selected and distinguished visually from the other directory items. For example, when the user touches the directory item 3238, the directory item 3238 may be displayed in a different color to be distinguished from the other directory items 3240, 3242, 3244, 3246, and 3248. A memo window 3231 may be rendered semi-transparent. The memo window 3231 may be overlapped over the directory application being a lower-layer application and the directory items 3240, 3242, 3244, 3246, and 3248 may show through the memo window 3231. When the user inputs a predefined gesture onto the touch panel during execution of the directory application in progress, the controller detects the predefined gesture from the touch panel and displays the memo window 3231 overlapped with the directory application in response to the detected gesture. The memo window 3231 is divided into a handwriting input area and a non-handwriting input area. Since the directory application is displayed on the touch panel and the memo window is displayed over the directory application, the directory application is called a lower-layer application.

The predefined gesture may be a touch on a specific area of the touch panel. Alternatively, the predefined gesture may be a drag on the touch panel. Alternatively, the predefined gesture may be to draw a predefined shape on the touch panel using an electronic pen. The electronic pen may be a stylus pen. Alternatively, the predefined gesture may be to swipe on the touch panel using the stylus pen.

As mentioned before, the memo window 3231 may include the non-handwriting input area. In the non-handwriting input area, a text and an image received from the lower-layer application may be displayed. The non-handwriting input area may be a title area 3232. In addition, the non-handwriting input area may include a button 3236 that can be manipulated by the user. The button 3236 may be an image received from the lower-layer application.

The memo window 3231 may include a handwriting input area 3233 for receiving a note written by the user.

The title of the memo window 3231 may be displayed in the title area 3232. The title of the memo window 3231 may be received from the lower-layer application. For example, the controller may receive a title to be displayed in the title area 3232 from the lower-layer application and display the title in the title area 3232 of the memo window 3231. A touch input to the title area 3232 may be neglected. In the state where the directory items 3238, 3240, 3242, 3244, 3246, and 3248 are displayed, the controller may detect a touch. When the memo window 3231 is displayed, the controller may ignore a touch input detected from the title area 3231. When the memo window 3231 is activated, the controller may execute a command for controlling the lower-layer application only through the handwriting input area 3233 of the memo window 3231. In addition, when the memo window 3231 is activated, the controller may ignore a touch input generated from the first menu items 3252, 3254, 3256, and 3258 used for controlling the lower-layer application.

For example, ‘Memo Layer’ may be displayed in the title area 3232 of the memo window 3231.

The text ‘Memo Layer’ may be received from the directory application being a lower-layer application.

The handwriting input area 3233 may receive a handwriting input from the user. The handwriting input may be a continuous movement of a touch on the touch panel. The handwriting input may be created by a user's action of inputting characters on the touch panel with a stylus pen or a finger.

When the user writes a note in the handwriting input area 3233, the controller may display the handwriting image of the note in the handwriting input area 3233. For example, the controller may receive a note that the user writes in the handwriting input area with a stylus pen or a finger.

Before the memo window 3231 is displayed, the controller may detect a touch in the handwriting input area 3233 on the touch panel and perform a function corresponding to the touch. For example, before the memo window 3231 is displayed, the directory items 3238, 3240, 3242, 3244, and 3246 may be displayed on the touch panel. When the user touches the directory item 3238, the controller may change the color of the directory item 3238 in response to the touch. When the memo window 3231 is displayed on the touch panel, the controller may ignore a touch input to the touch panel. When the memo window 3231 is displayed, the user may not be allowed to touch the directory items 3238, 3240, 3242, 3244, and 3246. For example, when the memo window 3231 is displayed over buttons (menu items), the buttons (menu items) are deactivated.

When the memo window 3231 is displayed, the user may input a command and data needed to execute the command to the currently executed application by a handwriting input. For example, before the memo window 3231 is displayed, the user may input a command and data needed to execute the command to the currently executed application by a touch input. Once the memo window 3231 is displayed, the user may input a command and data needed to execute the command to the currently executed application by a handwriting input.

The handwriting input may be created by moving a stylus pen. When the user touches the touch panel and moves the touch with the stylus pen, the controller may detect the movement of the stylus pen on the touch panel and display the moving trajectory of the stylus pen on the touch panel. The moving trajectory of the stylus pen is a handwriting image. A handwriting input may also be created by moving a user's finger.

The button 3236 available for a user's manipulation may be displayed in the memo window 3231. The button 3236 may be provided by the lower-layer application. The lower-layer application has an image of the button 3236 to be displayed in the memo window 3231. The image may be a text, an image, an icon, or the like.

Upon detecting a touch on the text or image displayed in the memo window, the controller may recognize a handwriting image input to the handwriting input area, convert the handwriting image into matching text, and provide the text to the application.

For example, when the controller touches the button 3236, the controller may recognize an input handwriting image and perform a function of the application according to the recognized result.

In addition, the controller may recognize a handwriting image in the handwriting input area 3233. When the user touches the button 3236, the controller transmits the handwriting image displayed in the handwriting area 3233 to the recognition engine 210. The recognition engine 210 may recognize the handwriting image and convert the handwriting image to text. For example, when the user writes a note in the handwriting input area 3233 by handwriting, the controller displays a handwriting image 3234 of the note. When the user touches the button 3236 with the handwriting image 3234 displayed in the handwriting input area 3233, the controller transmits the handwriting image 3234 to the recognition engine 210 and the recognition engine 210 recognizes the handwriting image 3234 and provides text ‘Merge’ to the controller. The recognition engine 210 may be a software module. The controller may provide the recognized result to the lower-layer application. The controller may control execution of a ‘Merge’ function in the directory application being the lower-layer application.

The recognized image may be a command requesting execution of a specific function in the lower-layer application. The lower-layer application may define and manage commands for executing specific functions. If the recognized handwriting image is identified as a command, the controller may control execution of an operation corresponding to the command in the lower-layer application. For example, the directory application may define and manage ‘Delete’, ‘Profile’, ‘Sync’, and ‘Merge’ as commands to execute functions. The commands fully or partially match the text of the menu items 3216, 3218, 3220, 3222, 3224, and 3226 included in the second menu area of FIG. 32A.

When the user touches the button 3236, the controller may eliminate the memo window 3231 and control execution of the operation corresponding to the recognized result in the lower-layer application.

FIG. 32C illustrates a user input of a handwriting image in a memo window according to an exemplary embodiment of the present invention.

Referring to FIG. 32C, a directory area 3270 may be displayed on the touch panel. When the user writes a note in a handwriting input area 3272, a handwriting image 3274 is displayed. The controller may recognize the handwriting image 3274 and control execution of an operation corresponding to the recognized result in the lower-layer application.

The controller may control the lower-layer application displayed on the touch panel to operate in two modes. Once the lower-layer application is executed, the controller may display a graphic object representing information about the lower-layer application and buttons (menu items) for controlling functions of the lower-layer application on the touch panel. The controller may support first and second modes. The controller controls a function of an executed application by a touch input in the first mode, whereas the controller identifies a predefined gesture on the touch panel during execution of the application in progress, displays a memo window allowing handwriting inputs over the application in correspondence with the identified result, recognizes a handwriting image input to the memo window, and controls a function of the application in the second mode. In addition, the controller may control deactivation of the first mode in the second mode.

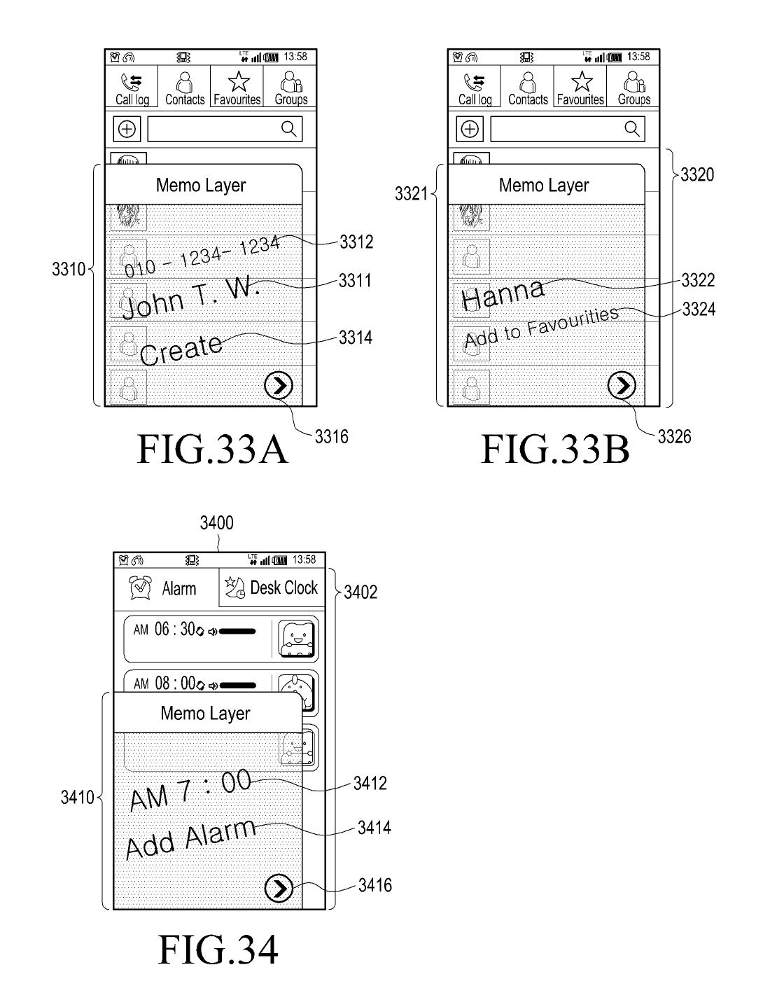

FIGS. 33A through 33B illustrate operation for processing a handwriting image that a user inputs in a memo window according to an exemplary embodiment of the present invention.

Referring to FIG. 33A, when the user writes a note in a memo window 3310, the controller displays handwriting images 3311, 3312, and 3314. When the user touches a button 3316, the handwriting images 3311, 3312, and 3314 may be recognized. As a consequence, the controller may obtain text ‘010-1234-1234’, ‘John T. W.’, and ‘Create’ and provides the text to a lower-layer application. The lower-layer application may separate the text received from the memo window 3310 into a command for controlling a function of the lower-layer application and data for which the command is to be executed. For example, the text ‘Create’ is managed as a command in a directory application being the lower-layer application. The controller may control generation of a new contact in the directory application to execute the ‘Create’ command. To generate the new contact, a phone number and a contact name are needed. Thus, the controller may control storing of ‘010-1234-1234’ as a phone number in the directory application. The controller may further control storing of ‘John T. W.’ as a contact name in the directory application. In this manner, the recognized handwriting images may be classified into a command and data for which the command is to be executed in the lower-layer application.

Referring to FIG. 33B, a directory area 3320 may be displayed on the touch panel. When the user writes a note in a memo window 3321, the controller displays handwriting images 3322 and 3324. The controller may identify the handwriting images 3322 and 3324 as data and a command according to their input order. For example, if the user inputs the handwriting image 3322 first and then the handwriting image 3324 and touches a button 3326, the controller processes the handwriting image 3322 as data and the handwriting image 3324 as a command. To process the handwriting image 3324 as a command, the controller may compare a recognized result of the handwriting image 3322 with the commands managed in the directory application and control execution of a function corresponding to the matching command. The controller may add ‘Hanna’ to ‘Favorites’ by recognizing the handwriting images 3322 and 3324 displayed on the touch panel through handwriting recognition. For example, the controller executes the ‘Favorites’ command of the directory application, using ‘Hanna’ as data for which the command is to be executed.

FIG. 34 illustrates an operation for displaying a memo window and for receiving an input handwriting image during execution of an alarm application in progress according to an exemplary embodiment of the present invention.

Referring to FIG. 34, an execution screen 3402 of the alarm application is displayed on the touch panel 3400. When the user inputs a predefined gesture during execution of the alarm application in progress, a memo window 3410 is displayed on the touch panel 3400. Upon a user input of handwriting images 3412 and 3414 in the memo window 3410 with a stylus pen, the controller may display the input handwriting images 3412 and 3414. For instance, when the user writes ‘AM 7:00’ and ‘Add alarm’ in the memo window 3410, the controller displays the handwriting images 3412 and 3414 in the memo window 3410. When the user touches a button 3416, the controller may control recognition of the handwriting images 3412 and 3414. The controller may transmit the recognized result to the alarm application and control the alarm application to emit an alarm at 7:00 AM. Furthermore, the controller may process the handwriting image 3412 as data and the handwriting image 3414 as a command separately. Commands may be preset and managed in the alarm application.

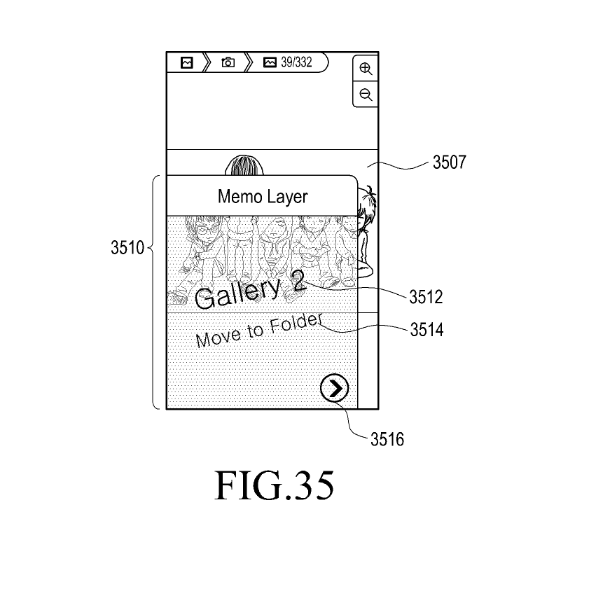

FIG. 35 illustrates an operation for displaying a memo window and for executing a command according to an input handwriting image, during execution of a gallery application in progress according to an exemplary embodiment of the present invention.

Referring to FIG. 35, the gallery application is displayed on the touch panel. The gallery application is an application for displaying an image file on a screen. When the user inputs a predefined gesture during execution of the gallery application in progress, the controller displays a memo window 3510 over the screen of the gallery application. When the user writes a note in the memo window 3510 and touches a button 3516, the controller recognizes input handwriting images 3512 and 3514 of the note and converts the handwriting images 3512 and 3514 to text. The controller may process the handwriting image 3512 as data and the handwriting image 3514 as a command.

For example, the user executes the gallery application and thus an image 3507 is displayed on the touch panel. In this state, the memo window 3510 is launched. When the user writes ‘Gallery 2’ and ‘Move to Folder’ in the memo window 3510, the controller moves the displayed image 3507 of the gallery application to a folder ‘Gallery 2’. The controller may process handwriting images separately as data and a command according to their input order. If text resulting from recognizing a user-input handwriting image fully or partially matches a command managed in the application, the controller may process the text as the command.

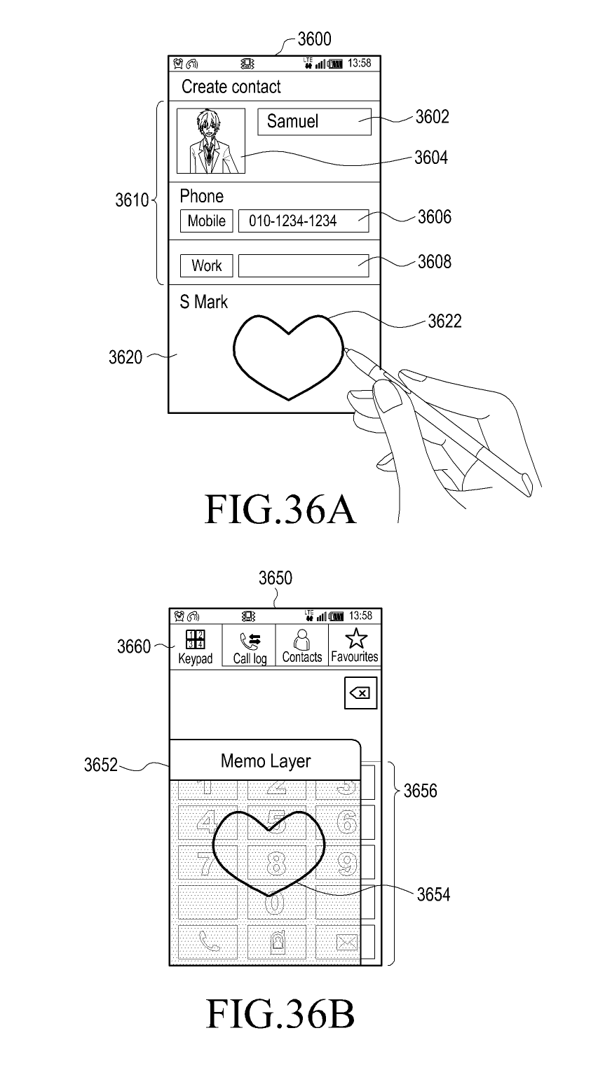

FIGS. 36A and 36B illustrates an application for executing a command according to a handwriting input according to an exemplary embodiment of the present invention.

Referring to FIG. 36A, an area 3610 for inputting and editing information about a contact (a called party) and an area 3620 for inputting a symbol used to invoke the contact are displayed on the touch panel 3600.

The information about the contact may include a name 3602, picture 3604, a mobile phone number 3606 and a work phone number 3608 of the contact. If the user has already input the information about the contact, the information about the contact may be displayed on the touch panel 3600. Otherwise, the information about the contact may be left empty.

The user may input or edit the contact information in the area 3610 and may input a symbol with which to invoke the contact in the area 3620 by handwriting. For example, the user may draw a ‘heart’ symbol 3622 as a handwriting image to invoke the contact.

Referring to FIG. 36B, a keypad 3656 is displayed on a touch panel 3650. The keypad may be a part of the directory application. When the user selects a keypad menu 3660 to call ‘Samuel’ during execution of the directory application in progress, the controller controls display of the keypad 3656 on the touch panel 3650. The user may invoke a memo window 3652 by a predefined gesture. Thereafter, when the user draws a specific shape in the memo window 3652 with a stylus pen, the controller recognizes the specific shape. The controller provides the recognized result of the specific shape to the directory application. The directory application may search for a contact including data about the specific shape in a directory database. The controller may call the contact including the data about the specific shape.

For example, when the user draws a ‘heart’ 3654 in the memo window 3652, the controller may recognize the ‘heart’ 3654 and search for a phone number of ‘Samuel’ 3602 including the ‘heart’ 3654. In addition, the controller may call ‘Samuel’ 3602 being the contact including the ‘heart’ 3654 according to the search result.

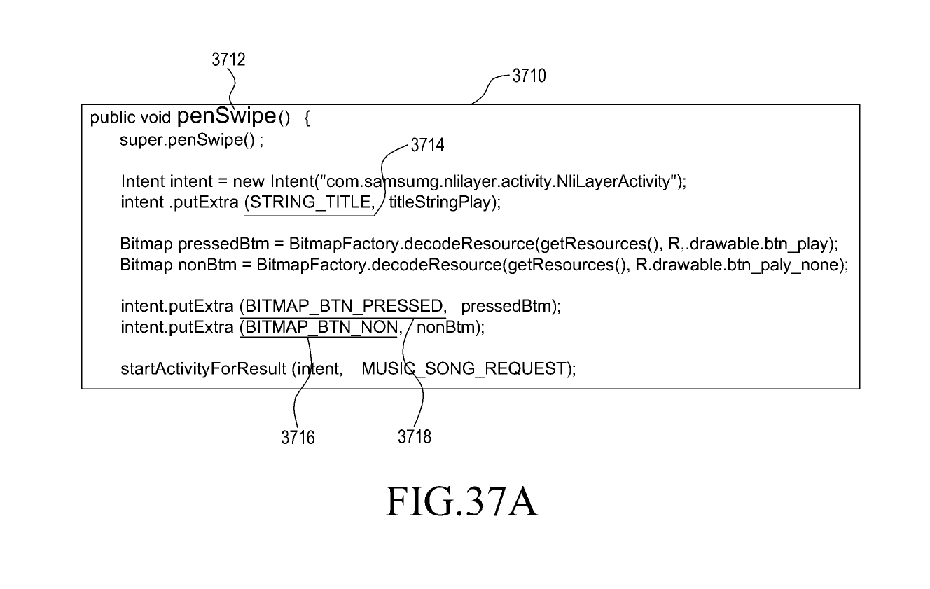

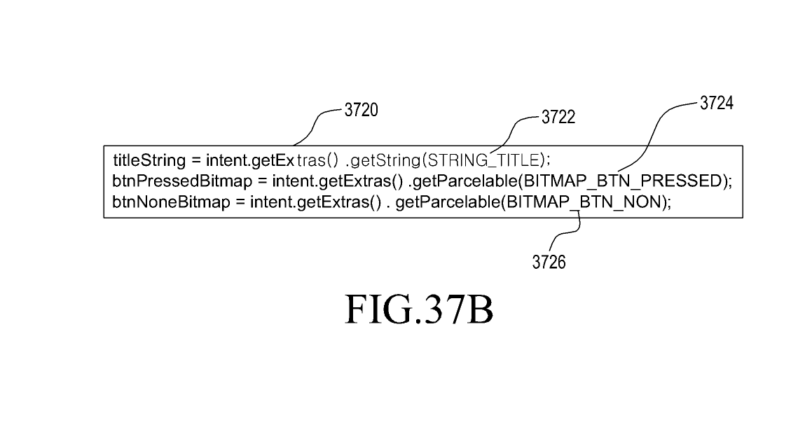

FIGS. 37A and 37B illustrate software modules included in a lower-layer application and a memo-layer (memo-window) application according to an exemplary embodiment of the present invention.

In an electronic device having a touch panel that detects a touch, when an application is executed, a graphic object representing information about the executed application and a button for controlling a function of the application are displayed on the touch panel.

Upon detection of a touch on the button, a controller may control the function of the application corresponding to the button. Upon detection of a predefined gesture on the touch panel, the controller may display a memo window over the graphic object and the button on the touch panel. The memo window is divided into a handwriting input area and a non-handwriting input area. The application includes a software module in which parameters required to display the memo window (i.e., the memo layer) are defined.

When the application is executed, the parameters are stored in a specific area of a memory (not shown) and used as text representing the title of the memo window and a button image displayed in the memo window.

Referring to FIG. 37A, a software module 3710 included in a lower-layer application is shown. The software module 3710 defines a module title 3712 and parameters 3714, 3716, and 3718 used in the software module 3710. When the lower-layer application is executed, a part of the memory (not shown) may be allocated to the lower-layer application. Data to be used as the parameters 3714, 3716, and 3718 may be stored in the partial area of the memory.

Referring to FIG. 37B, a software module 3720 for displaying the memo window is shown. The software module 3720 defines parameters 3722, 3724, and 3726 used to display the memo window. The parameters 3722, 3724, and 3726 are the same as the parameters 3714, 3716, and 3718 included in the software module 3710 of the lower-layer application. For example, the parameters 3722, 3724, and 3726 defined in the software module 3710 of the lower-layer application are available in displaying the memo window.

For example, STRING TITLE 3714, BITMAP_BTN_PRESSED 3718, and BITMAP_BTN_NON 3716 are defined as parameters in the software module 3710.

Text data used to display the title of the memo window is stored in STRING TITLE 3714.

Image data used to display a button in the memo window is stored in BITMAP_BTN_PRESSED 3718 and BITMAP_BTN_NON 3716.

The controller may use data stored in a memory area set for the memo layer in order to display the memo window on the touch panel. The controller may read the parameters 3714, 3716, and 3718 in the memory area allocated to the lower-layer application and use them to display the memo window.

As is apparent from the above description, exemplary embodiments of the present invention can increase user convenience by supporting a memo function in various applications and thus, allow intuitive control of the applications.

The above-described scenarios are characterized in that when a user launches a memo layer on a screen and writes information on the memo layer, the user terminal recognizes the information and performs an operation corresponding to the information. For this purpose, it will be preferred to additionally specify a technique for launching a memo layer on a screen.

For example, the memo layer may be launched on a current screen by pressing a menu button, inputting a specific gesture, keeping a button of a touch pen pressed, scrolling up or down a screen with a finger, or the like. While the screen is scrolled up to launch a memo layer in an exemplary embodiment of the present invention, many other techniques are available.

It will be understood that the exemplary embodiments of the present invention can be implemented in hardware, software, or a combination thereof. The software may be stored in a volatile or non-volatile memory device, such as a Read Only Memory (ROM) irrespective of whether data is deletable or rewritable, in a memory, such as a Random Access Memory (RAM), a memory chip, a device, or an integrated circuit, or in a storage medium to which data can be recorded optically or magnetically and from which data can be read by a machine (e.g., a computer), such as a Compact Disc (CD), a Digital Video Disc (DVD), a magnetic disk, or a magnetic tape.

Furthermore, the controlling of an application by handwriting image recognition according to exemplary embodiments of the present invention can be implemented in a computer or portable terminal that has a controller and a memory, and the memory is an example of a machine-readable (computer-readable) storage medium suitable for storing a program or programs including commands to implement the exemplary embodiments of the present invention. Accordingly, exemplary embodiments of the present invention include a program having a code for implementing the apparatuses or methods defined by the claims and a storage medium readable by a machine that stores the program. The program can be transferred electronically through a medium, such as a communication signal transmitted via a wired or wireless connection, the equivalents of which are included in exemplary embodiments of the present invention.

The exemplary method and apparatus for controlling an application by handwriting image recognition can receive and store the program from a program providing device connected by cable or wirelessly. The program providing device may include a program including commands to implement the exemplary embodiments of the present invention, a memory for storing information required for the exemplary embodiments of the present invention, a communication module for communicating with the apparatus by cable or wirelessly, and a controller for transmitting the program to the apparatus automatically or upon request of the apparatus.

For example, it is assumed in the exemplary embodiments of the present invention that a recognition engine configuring a UI analyzes a user's intention based on a recognized result and provides the result of processing an input based on the user intention to a user and these functions are processed within a user terminal.

However, it may be further contemplated that the user executes functions required to implement exemplary embodiments of the present invention in conjunction with a server accessible through a network. For example, the user terminal transmits a recognized result of the recognition engine to the server through the network. Thereafter, the server assesses the user's intention based on the received recognized result and provides the user's intention to the user terminal. If additional information is needed to assess the user's intention or process the user's intention, the server may receive the additional information by a question and answer procedure with the user terminal.

In addition, the user may limit the operations of exemplary embodiments of the present invention to the user terminal or may selectively extend the operations of exemplary embodiments of the present invention to interworking with the server through the network by adjusting settings of the user terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling an application in an electronic device having a touch panel, the method comprising:
displaying an executed application on the touch panel;
detecting a predefined user input;
displaying a memo window over the application in response to the detected user input, wherein the memo window includes a handwriting input area and a non-handwriting input area;
receiving a handwriting image in the handwriting input area of the memo window; and
recognizing the received handwriting image.

2. The method of claim 1, wherein the user input is one of a gesture on the touch panel, a touch on a virtual button in the touch panel, and a user selection of a physical button.

3. The method of claim 1, wherein at least one of a text and an image received from the application are displayed in the non-handwriting input area of the memo window.

4. The method of claim 3, wherein, when a touch on the non-handwriting input area is detected, the memo window recognizes the handwriting image input to the handwriting input area, converts the recognized handwriting image to text matching the handwriting image, and provides the text to the application.

5. The method of claim 4, further comprising:
separating the text received from the memo window into a command for controlling the function of the application and data related to the command by the application.

6. A method for controlling an application in an electronic device having a touch panel, the method comprising:
displaying a graphic object representing information related to an executed application and a button for controlling a function of the application on the touch panel;
controlling the function of the application corresponding to the button, upon detection of a touch on the button;
displaying a memo window over at least one of the graphic object and the button on the touch panel, upon detection of a predefined input on the touch panel, the memo window including a handwriting input area and a non-handwriting input area;
receiving a handwriting image in the handwriting input area of the memo window;
recognizing the received handwriting image; and
controlling a function of the application according to a recognized result.

7. The method of claim 6, wherein at least one of a text and an image received from the application are displayed in the non-handwriting input area of the memo window.

8. The method of claim 7, wherein, when a touch on the text and the image is detected, the memo window recognizes the handwriting image input to the handwriting input area, converts the recognized handwriting image to text matching the handwriting image, and provides the text to the application.

9. The method of claim 6, wherein, when the memo window is displayed over the button, the button is deactivated.

10. A method for controlling an application in an electronic device having a touch panel, the method comprising:
controlling a function of an executed application, upon detection of a touch input in a first mode; and
identifying a predefined input on the touch panel during execution of the application in progress, displaying a memo window that allows a handwriting input over the application according to the identified input, recognizing a handwriting image input to the memo window, and controlling a function of the executed application according to the recognized handwriting image in a second mode.

11. The method of claim 10, wherein the first mode is deactivated in the second mode.

12. An electronic device comprising:
a touch panel for detecting a touch; and
a controller for displaying an executed application on the touch panel, for displaying a memo window over the application in response to a predefined input detected from the touch panel, wherein the memo window includes a handwriting input area and a non-handwriting input area, for recognizing a handwriting image to the handwriting input area of the memo window, and for controlling a function of the application according to a recognized result.

13. The electronic device of claim 11, wherein the controller controls display of at least one of a text and an image received from the application in the non-handwriting input area of the memo window.

14. The electronic device of claim 13, wherein, upon detecting a touch on the non-handwriting area, the controller recognizes the handwriting image input to the handwriting input area, converts the recognized handwriting image to text matching the handwriting image, and controls a function of the application corresponding to the text.

15. The electronic device of claim 14, wherein the controller separates the text into a command for controlling the function of the application and data related to the command.

16. An electronic device comprising:
a touch panel for detecting a touch; and
a controller for displaying a graphic object representing information related to an executed application and a button for controlling a function of the application on the touch panel, for controlling the function of the application corresponding to the button, upon detection of a touch on the button, for displaying a memo window over at least one of the graphic object and the button on the touch panel, upon detection of a predefined input on the touch panel, wherein the memo window includes a handwriting input area and a non-handwriting input area, for recognizing a handwriting image input to the handwriting input area of the memo window, and for controlling execution of a function of the application according to a recognized result.

17. The electronic device of claim 16, wherein the controller controls display of at least one of a text and an image received from the application in the non-handwriting input area of the memo window.

18. The electronic device of claim 17, wherein, upon detecting a touch on the text and the image, the controller recognizes the handwriting image input to the handwriting input area, converts the recognized handwriting image to text matching the handwriting image, and controls a function of the application corresponding to the text.

19. The electronic device of claim 16, wherein, when the memo window is displayed over the button, the controller controls deactivation of the button.

20. An electronic device comprising:
a touch panel for detecting a touch; and
a controller for operating in a first mode in which the controller controls a function of an executed application, upon detection of a touch input, and for operating in a second mode in which the controller identifies a predefined input on the touch panel during execution of the application in progress, displays a memo window that allows a handwriting input over the application according to the identified input, recognizes a handwriting image input to the memo window, and controls a function of the executed application according to the recognized handwriting image.

21. An electronic device comprising:
a touch panel for detecting a touch; and
a controller for displaying a graphic object representing information related to an executed application and a button for controlling a function of the application on the touch panel, for controlling execution of the function of the application corresponding to the button, upon detection of a touch on the button, for displaying a memo window allowing a handwriting input over a screen displaying the graphic object and the button on the touch panel, upon detection of a predefined input on the touch panel, for recognizing a handwriting image input to the memo window, and for controlling execution of a function of the application according to a recognized result.
